(19) United States
(12) Patent Application Publication
(10) Pub. No.: US 2024/0347250 A1
(43) Pub. Date: Oct. 17, 2024

(54) NESTED CARRIER ACTUATORS FOR MOVING OPTICAL COMPONENTS

(71) Applicant: Apple Inc., Cupertino, CA (US)

(72) Inventors: Sinclair A. Minshull, Sunnyvale, CA (US); Sanush N. Kehelella, Santa Clara, CA (US)

(21) Appl. No.: 18/632,061

(22) Filed: Apr. 10, 2024

Related U.S. Application Data
(60) Provisional application No. 63/458,580, filed on Apr. 11, 2023.

(51) Int. Cl. H01F 7/06; G02B 5/02; H01F 7/126; H01F 7/16

(52) U.S. Cl. CPC H01F 7/064; G02B 5/0273; H01F 7/126; H01F 7/16; H01F 2007/1692

(57) ABSTRACT

Various embodiments disclosed herein describe electromagnetic actuator arrangements having nested carriers. The nested carriers include an intermediate carrier moveably connected to a stationary base, and an inner carrier moveably coupled to the intermediate carrier. The inner carrier may carry an optical component, such as a diffuser, and may move the optical component relative to the stationary base by controlling the movement of the intermediate and/or inner carrier.

### FIELD

This application is a nonprovisional and claims the benefit under 35 U.S.C. 119(e) of U.S. Provisional Patent Application No. 63/458,580, filed Apr. 11, 2023, the contents of which are incorporated herein by reference as if fully disclosed herein.

### FIELD

The described embodiments relate generally to actuator designs for moving components of an optical system. More particularly, the described embodiments describe nested carrier arrangements, as well as optical systems incorporating such arrangements, that provide different movement capabilities in different directions.

### BACKGROUND

Electromagnetic actuator arrangements are frequently used to move optical components, such as lens or image sensors, in an optical system. For example, a voice coil actuator (also called “voice coil motors” or “voice coil motor actuators”) utilizes one or more magnets and one or more coils to generate Lorentz forces when current is driven through the one or more coils. Either the one or more magnets or one or more coils may be connected to a suspended carrier that is suspended relative to a stationary base component. An optical component is carried by the suspended carrier, and the Lorentz forces may move the suspended carrier and the optical component in one or more directions relative to a stationary base. The overall power efficiency of a given actuator arrangement may be limited depending on its design and intended use. Thus, electromagnetic actuator arrangements with increased power efficiency may be desirable for certain applications.

### SUMMARY

Described herein are electromagnetic actuator arrangements that utilize nested carriers to move an optical component relative to a stationary base. In some embodiments, an optical system includes an electromagnetic actuator arrangement having a nested carrier. The nested carrier may include a stationary base, a first set of suspension elements, an intermediate carrier moveably connected to the stationary base via the first set of suspension elements, a second set of suspension elements, and an inner carrier moveably connected to the intermediate carrier via the second set of suspension elements. The optical system may further include a diffuser carried by the inner carrier, a first set of actuators mounted to the intermediate carrier and controllable to move the intermediate carrier relative to the stationary base along a first direction, and a second set of actuators mounted to the inner carrier and controllable to move the inner carrier relative to the intermediate carrier along a second direction.

In some instances, the optical system further includes a beam-generating assembly configured to generate a set of light beams, wherein the diffuser is positioned to receive a first light beam of the set of light beams. In some of these variations, the first light beam has a cross-sectional shape at the diffuser, the cross-sectional shape having a length that is longer than a width thereof, and the length is aligned with the second direction.

Additionally or alternatively, the inner carrier may be a first inner carrier and the nested carrier includes a third set of suspension elements and a second inner carrier moveably connected to the intermediate carrier via the third set of suspension elements. In these variations, the optical system may include a third set of actuators mounted to the second inner carrier and controllable to move the second inner carrier relative to the intermediate carrier along the second direction. The second inner carry may carry an optical element, which in some instances may be a second diffuser. The optical element may be positioned to receive a second light beam generated by the beam-generating assembly.

The optical system may include a set of detector groups positioned to receive light from the set of light beams that is returned from the sample. Additionally or alternatively, the nested carrier may be monolithic.

Other embodiments are directed to electromagnetic actuator arrangements that include a planar nested carrier. The planar nested carrier may include a stationary base, a first set of suspension elements, an intermediate carrier moveably connected to the stationary base via the first set of suspension elements, a second set of suspension elements, and an inner carrier moveably connected to the intermediate carrier via the second set of suspension elements. An optical component may be carried by the inner carrier, and the electromagnetic actuator arrangement may include a first set of actuators mounted to the intermediate carrier and controllable to move the intermediate carrier relative to the stationary base along a first planar direction and a second set of actuators mounted to the inner carrier and controllable to move the inner carrier relative to the intermediate carrier along a second planar direction.

In some of these embodiments, the intermediate carrier is controllable to move relative to the stationary base only in the first planar direction and the inner carrier is controllable to move relative to the stationary base only in the second planar direction. Additionally or alternatively, the optical component is a diffuser. In some variations, the inner carrier is a first inner carrier, the optical component is a first optical component, and the planar nested carrier includes a third set of suspension elements and a second inner carrier moveably connected to the intermediate carrier via the third set of suspension elements. In these variations, the electromagnetic actuator arrangement may include a second optical component carried by the second inner carrier and a third set of actuators mounted to the second inner carrier and controllable to move the second inner carrier relative to the intermediate carrier along the second planar direction. In some variations, the second optical component is a diffuser.

In some variations, the planar nested carrier is monolithic. Additionally or alternatively, the planar nested carrier is configured such that the first set of suspension elements includes a first group of suspension elements and a second group of suspension elements. In these instances, the first group of the first set of suspension elements may connect a first side of the stationary base to a first side of the intermediate carrier facing the first side of the stationary base, and the second group of the first set of suspension elements may connect a second side of the stationary base to a second side of the intermediate carrier facing the second side of the stationary base. Additionally or alternatively, planar nested carrier may be configured such that the second set of suspension elements comprises a first group of suspension elements and a second group of suspension elements. The first group of the second set of suspension elements may connect a third side of the intermediate carrier to a first side of the inner carrier facing the third side of the intermediate carrier, and the second group of the second set of suspension elements may connect a fourth side of the intermediate carrier to a second side of the inner carrier facing the fourth side of the intermediate carrier.

Still other embodiments are directed to performing a series of measurements using an optical system. The optical system may include an electromagnetic actuator arrangement having a nested actuator, and the method may include moving an intermediate carrier of the nested actuator relative to a stationary base of the nested actuator between a first set positions along a first direction. The method may further include collecting a set of measurements at each of the first set of positions along the first direction. Collecting the set of measurements at a given position within the first set of positions may include moving an inner carrier of the nested actuator relative to the intermediate carrier between each of a second set positions along a second direction different than the first direction, and performing, using an optical component carried by the inner carrier, an individual measurement of set of measurements at each of the second set of positions along the second direction.

In some variations, the optical component is a diffuser, and performing, using the optical component carried by the inner carrier, the individual measurement includes diffusing a light beam using the diffuser. In some of these variations, the light beam has a cross-sectional shape at the diffuser, the cross-sectional shape having a length that is longer than a width thereof; and the length is aligned with the second direction.

Additionally or alternatively, the method may further include collecting an additional set of measurements at each of the first set of positions along the first direction. Collecting the additional set of measurements at each of the first set of positions may include moving an additional inner carrier of the nested actuator relative to the intermediate carrier between each of a third set of positions along the second direction, and performing, using an additional optical component carried by the additional inner carrier, an additional individual measurement of set of measurements at each of the third set of positions along the second direction.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top view of a conventional electromagnetic actuator arrangement that is configured to move an optical component in two directions relative to a stationary base.

FIG. 2A shows a top view of a variation of electromagnetic actuator arrangements that include a nested carrier, such as described herein. FIGS. 2B and 2C show cross-sectional side views of variations of the electromagnetic actuator arrangement of FIG. 2A. FIG. 2D shows a top view of another variation of an electromagnetic actuator arrangement having a nested carrier with multiple inner carriers.

FIGS. 3A-3C show top views of variations of electromagnetic actuator arrangements that include a nested carrier, such as described herein.

FIG. 4A shows a schematic diagram of a variation of an optical system that incorporates an electromagnetic actuator arrangement as described herein. FIG. 4B shows a perspective view of a portion of the optical system of FIG. 4A. FIGS. 4C-4E show top views of a variation of the optical system of FIGS. 4A and 4B.

FIG. 5 depicts a method of collecting a series of measurements using an optical system as described herein.

FIGS. 6A, 6B, and 6C show perspective, side, and top views, respectively, of an electromagnetic actuator arrangement that includes a carrier that is vertically offset relative to a stationary base. FIG. 6D shows a top view of another variation of an electromagnetic actuator arrangement having a vertically-offset carrier with multiple inner carriers.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and subsettings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Directional terminology, such as “top”, “bottom”, “upper”, “lower”, “front”, “back”, “over”, “under”, “above”, “below”, “left”, “right”, “vertical”, “horizontal”, etc. is used with reference to the relative orientation of some of the components in some of the figures described below, and is not intended to be limiting as to overall orientation of a given component. Because components in various embodiments can be positioned in a number of different orientations, directional terminology is used for purposes of illustration only. For example, a “top surface” of a first component need not have any particular relative orientation to a “top surface” of a different component or of a device incorporating the first component unless one is specified. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to embodiments of electromagnetic actuator arrangements having nested carriers. The nested carriers include a stationary base, an intermediate carrier moveably connected to the stationary base, and an inner carrier moveably connected to the intermediate carrier. The inner carrier may carry an optical component (e.g., a diffuser), such that movement of the inner carrier within the electromagnetic actuator arrangement also moves the optical component within the electromagnetic actuator arrangement. For example, the intermediate carrier may be moved relative to the stationary base along a first direction to move the optical component in the first direction, while the inner carrier may be moved relative to the intermediate carrier along a different second direction to move the optical component in the second direction. In some instances, the nested carrier includes multiple inner carriers that are independently moveable relative to the intermediate carrier (e.g., along the same direction or along different directions).

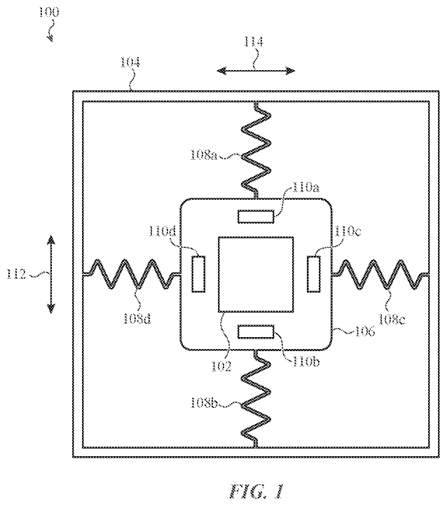

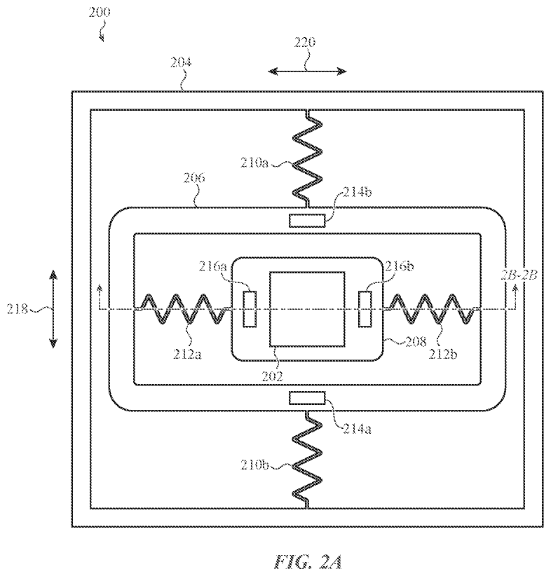

These and other embodiments are discussed with reference to FIGS. 1-5. However, those skilled in the art will readily appreciate that the detailed description given herein with respect to these figures is for explanatory purposes only and should not be construed as limiting.

FIG. 1 shows an example of a conventional electromagnetic actuator arrangement 100 that is configured to move an optical component 102 relative to a stationary base 104. It should be appreciated that the term “stationary”, when used herein in the context of an electromagnetic actuator arrangement, is intended as a relative term to indicate that positioning of a particular component is fixed within the electromagnetic actuator arrangement. Specifically, the electromagnetic actuator arrangement may include one or more “moveable” components that may be moved relative to other “stationary” components of the electromagnetic actuator arrangement. When such an electromagnetic actuator arrangement is incorporated into an optical system, it should be appreciated that this arrangement (including any stationary components thereof) need not remain stationary within the overall optical system. Indeed, the entire electromagnetic actuator arrangement may be moveable within the optical system, while the electromagnetic actuator arrangement may be controllable to create relative movement between its stationary and moveable components. As a result, a given component may be stationary within the electromagnetic actuator arrangement, but may not be stationary in the context of the overall optical system.

To move the optical component 102 relative to the stationary base 104, the electromagnetic actuator arrangement 100 includes a carrier 106 that is moveably connected to the stationary base 104 via a set of suspension elements 108a-108d. The suspension elements 108a-108d may include one or more flexures, sheet springs, or the like that are each connected to both the stationary base 104 and the carrier 106. In some instances, the stationary base 104, the carrier 106, and the set of suspension elements 108a-108d may be monolithic. For example, these components may be formed from a single sheet of material (e.g., a metal), in which some of the material is removed from the sheet to define the carrier 106 and the set of suspension elements 108a-108d.

The optical component 102 may be mounted to the carrier 106, such that movement of the carrier 106 relative to the stationary base 104 also moves the optical component 102 relative to the stationary base 104. To move the carrier 106 and optical component 102 relative to the stationary base 104, the electromagnetic actuator arrangement 100 includes a set of actuators 110a-110d. Each of these actuators 110a-110d is controllable to apply a force to the carrier 106 relative to the stationary base 104. Depending on the collective forces applied to the carrier 106 by the set of actuators 110a-110d, the carrier 106 may move in one or more directions relative the stationary base 104.

For example, the carrier 106 may have a planar shape (such as when the carrier is formed from a planar sheet of material) and the set of actuators 110a-110d may be configured to move the carrier 106 in multiple planar directions (e.g., within the plane defined by the carrier 106), such as a first planar direction 112 and a second planar direction 114 perpendicular to the first planar direction 112. The set of actuators 110a-110d may be controlled to collectively apply forces along one or both of the planar directions 112, 114 to move the carrier 106 accordingly. For example, each of a first actuator 110a and a second actuator 110b may be controllable to apply a corresponding force to the carrier 106 along the first planar direction 112, and thereby control movement of the carrier 106 along the first planar direction 112. Similarly, each of a third actuator 110c and a fourth actuator 110d may be controllable to apply a force to the carrier 106 along the second planar direction 114, and thereby control movement of the carrier 106 along the second planar direction 114. Collectively, the set of actuators 110a-110d may selectively move carrier 106 in both planar directions 112, 114 simultaneously.

The set of actuators 110a-110d may be any actuator capable of applying a force to the carrier 106 relative to the stationary base 104. For example, the set of actuators 110a-110d may each be configured as a voice coil motor (VCM) actuator that includes a magnet and a coil. Either the magnet or coil is connected to (and moveable with) the carrier 106, and the other of which is stationary with respect to the electromagnetic actuator arrangement 100. The magnet and coil are positioned sufficiently close to each other such that the magnet and coil generate a Lorentz force when current is driven through the coil. This Lorentz force is applied to the carrier 106 relative to the stationary base 104 to assist in moving the carrier 106.

It should be appreciated that different actuators may have different coils that interact with a common magnet, or vice versa. Additionally, various actuators within the set of actuators 110a-110d may be individually or jointly controlled. For example, in some variations the first and second actuators 110a, 110b may be jointly controlled (e.g., the coils from these actuators receive a common voltage or current), and the third and fourth actuators 110c, 110d may also be jointly controlled. In these variations, the first and second actuators 110a, 110b may be independently controlled relative to the third and fourth actuators 110c, 110d, which allows for independent control over movement along the first planar direction 112 and the second planar direction 114.

The suspension elements 108a-108d may be configured to facilitate movement of the carrier 106 in certain directions while limiting motion of the carrier 106 in other directions. For example, certain suspension elements 108a-108d may be configured with higher stiffness in certain directions, which may limit the directions in which carrier 106 may be moved relative to the stationary base 104. For example, in the electromagnetic actuator arrangement 100 shown in FIG. 1, the set of suspension elements 108a-108d may have lower stiffness in the first and second planar directions 112, 114, but have higher stiffness in an out-of-plane direction perpendicular to the first and second planar directions 112, 114. In these instances, the set of suspension elements 108a-108d may be more resistant to out-of-plane movement, thereby restricting unintentional movement in the out-of-plane direction.

The electromagnetic actuator arrangement 100 of FIG. 1 may be useful when the electromagnetic actuator arrangement 100 has similar requirements for motion in two axes (i.e., along the first and second planar directions 112, 114). For example, if the optical component 102 is an image sensor of a camera, the electromagnetic actuator arrangement 100 may move the image sensor laterally relative to the optical axis of the camera to perform optical image stabilization, thereby correcting for unintended motion of the camera (e.g., such as hand shake when a user holds the camera). Because the direction of this unintended motion may not be known in advance, the electromagnetic actuator arrangement 100 may need to readily move the image sensor in either or both of two axes.

In other optical systems, however, there may be different requirements for different motion directions of an optical component. For example, in some instances an optical system may be configured to move an optical component more frequently along a first axis relative to a second axis and/or may require a different stroke range along the first axis relative to the second axis. In these instances, the electromagnetic actuator arrangement 100 of FIG. 1 may consume more power moving the carrier along the first axis (e.g., along the first planar direction 112) than it does moving the carrier along the second axis (e.g., along the second planar direction 114). This may be compounded in the configuration of FIG. 1 because the carrier 106 includes all of the actuators (e.g., the set of actuators 108a-108d) needed to move the carrier 106 in both axes, thereby increasing the mass of the carrier 106 and the power required to move the carrier 106 in any direction.

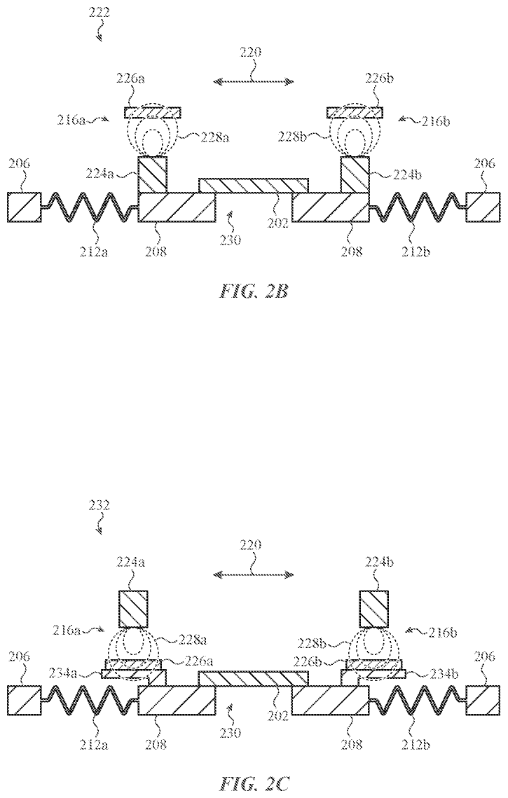

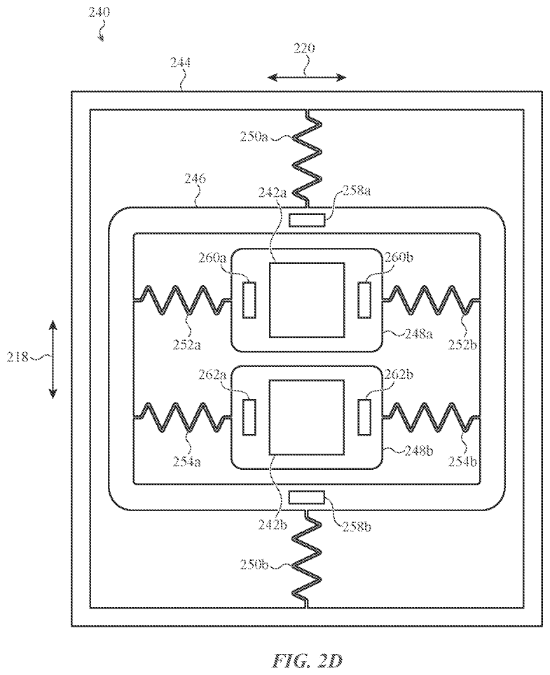

Conversely, the electromagnetic actuator arrangements described herein with respect to FIGS. 2A-5 utilize a nested carrier arrangement to decouple motion of an optical element between different axes. By decoupling motion between different axes, the electromagnetic actuator arrangement may be tuned to prioritize movement along a given axis, and may reduce power consumption when moving an optical element along this axis as compared to the electromagnetic actuator arrangement 100 of FIG. 1. Typically, the electromagnetic actuator arrangements described herein include a stationary base, an intermediate carrier moveably connected to the stationary base via a first set of suspension elements, and an inner carrier moveably connected to the intermediate base. An optical component may be carried by and moveable with the inner carrier. The inner carrier may be moved relative to the intermediate carrier in one direction to move the optical component in that direction, while the intermediate carrier may be moved relative to the stationary base in another direction to move the inner carrier and the optical component in that direction.

For example, FIG. 2A shows a top view of an example of an electromagnetic actuator arrangement 200 that includes a nested carrier configured to move an optical element 202 relative to a stationary base 204. Specifically, the nested carrier includes the stationary base 204, an intermediate carrier 206, and an inner carrier 208. The nested carrier may be planar, such that the components of the nested carrier are positioned (and for some components, moveable) within a plane. The electromagnetic actuator arrangement 200 is controllable to move the optical component 202 in multiple planar directions within this plane.

The nested carrier also includes a first set of suspension elements 210a-210b and a second set of suspension elements 212a-212b. The intermediate carrier 206 is moveably connected to the stationary base 204 via the first set of suspension elements 210a-210b, and the inner carrier 208 is moveably connected to the intermediate carrier 206 by a second set of suspension elements 212a-212b. While the first and second sets of suspension elements 210a-210b, 212a-212b are represented schematically in FIG. 2A by a generic spring symbol, it should be appreciated that these suspension elements may include one or more flexures, sheet springs, or the like, and may have any suitable shape as may be desired depending on the specifications of the electromagnetic actuator arrangement 200. In some instances, the nested carrier may be monolithic (i.e., the stationary base 204, the intermediate carrier 206, the first set of suspension elements 210a-210b, the inner carrier 208, and the second set of suspension elements 212a-212b are monolithically formed). For example, these components may be formed from a single sheet of material (e.g., a metal), in which some of the material is removed from the sheet to define the carriers 206, 208 and the sets of suspension elements 210a-210b, 212a-212b.

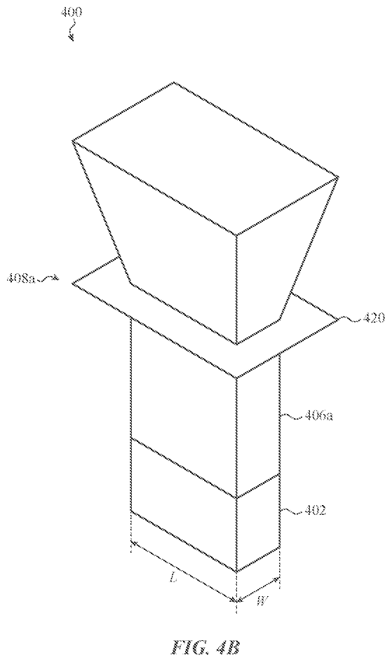

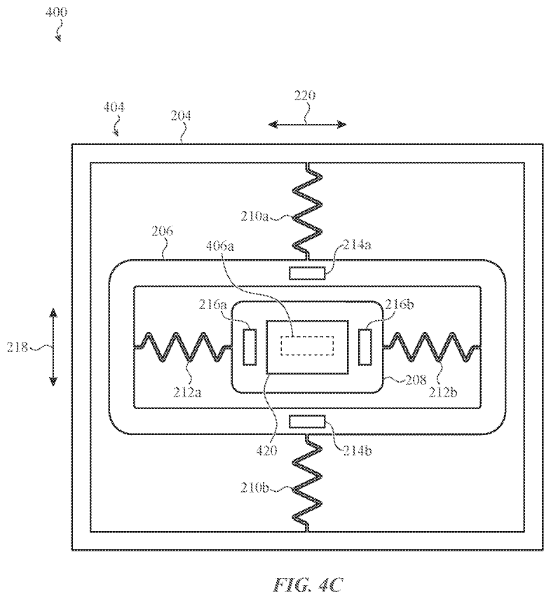

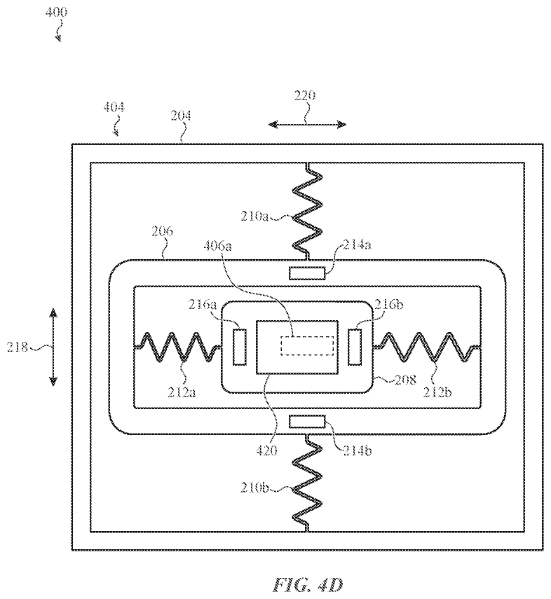

The optical component 202 is carried by and moveable with the inner carrier 208. For example, the optical component 202 may be mounted to the inner carrier 208 such that movement of the inner carrier 208 relative to the stationary base 204 also moves the optical component 202 relative to the stationary base 204. In the variation shown in FIG. 2A, the electromagnetic actuator arrangement 200 can move the optical component 202 relative to the stationary base 204 along two axes (e.g., along a first direction 218 and a second direction 220 that is perpendicular to the first direction 218). In instances where the electromagnetic actuator arrangement 200 includes a planar nested carrier, the first and second directions 218, 220 may represent different planar directions. When the electromagnetic actuator arrangement 200 is incorporated into an optical system, the optical component 202 may receive a light beam from an out-of-plane direction (e.g., along an optical axis of the optical component 202). The electromagnetic actuator arrangement 200 may be controlled to move the optical component 202 in multiple lateral directions relative to the incoming light beam, such as described herein with respect to FIGS. 4A-4E.

Accordingly, the optical component 202 may be moved in the same directions as the optical component 102 of FIG. 1, except that the motion of the optical component 202 is decoupled between motion of the inner carrier 208 relative to the intermediate carrier 206 and motion of the intermediate carrier 206 relative to the stationary base 204. Specifically, the electromagnetic actuator arrangement 200 controls movement of the optical component along a first axis (e.g., along the first direction 218) by moving the intermediate carrier 206 relative to the stationary base 204 along the first direction 218, which also moves the inner career 206 relative to the stationary base 204 along the first direction 218. The electromagnetic actuator arrangement 200 controls movement of the optical component along a second axis (e.g., along the second direction 220) by moving the inner carrier 208 relative to the intermediate carrier 206 along the second direction 220.

To facilitate this movement, the electromagnetic actuator arrangement 200 includes multiple sets of actuators, where different sets of actuators are configured to control different directions of movement of the optical component 202. For example, the electromagnetic actuator arrangement 200 includes a first set of actuators 214a-214b and a second set of actuators 216a-216b. The first set of actuators 214a-214b is mounted to the intermediate carrier 206, and each of these actuators is controllable (alone or collectively) to apply a force to the intermediate carrier 206 relative to the stationary base 204 along the first direction 218. Accordingly, the first set of actuators 214a-214b is controllable to move the intermediate carrier 206 relative to the stationary base 204 along the first direction 218. By virtue of the connection between the inner carrier 208 and the intermediate carrier 206 (via the second set of suspension elements 212a-212b), movement of the intermediate carrier 206 along the first direction 218 will also move the inner carrier 208 (and with it, the optical element 202) along the first direction 218.

Similarly, a second set of actuators 216a-216b is mounted to the inner carrier 208, and each of these actuators is controllable (alone or collectively) to apply a force to the inner carrier 208 relative to the intermediate carrier 206 along the second direction 220. Accordingly, the second set of actuators 216a-216b is controllable to move the inner carrier 208 relative to both the intermediate carrier 206 and the stationary base 204 along the second direction 220. As a result, the first set of actuators 214a-214b is used to move the optical element 202 along the first direction 218, and the second set of actuators 216a-216b is used to move the optical element 202 along the second direction 220.

In some variations, the intermediate carrier 206 is controllable to move in only a single direction relative to the stationary base 204. In other words, the electromagnetic actuator arrangement may be unable to controllably move the intermediate carrier 206 in directions other than the first direction 218 (e.g., the intermediate carrier 206 only includes actuators that are configured to move the intermediate carrier 206 relative to the stationary base 204 in the first direction 218). In instances where the electromagnetic actuator arrangement 200 includes a planar nested carrier, the intermediate carrier 206 may be controllable to move only in a first planar direction (i.e., the first direction 218) within the plane of the nested carrier. It should be appreciated that in practice there may still be some relative movement in other directions that result from unexpected movement of or other forces applied to the electromagnetic actuator arrangement 200 (e.g., if an optical system incorporating the electromagnetic actuator arrangement experiences accelerations or forces applied thereto).

In these variations, the first set of suspension elements 210a-210b may be configured to prioritize relative movement between the intermediate carrier 206 and the stationary base 204 along the first direction 218. For example, each of the first set of suspension elements 210a-210b may have greater flexibility along the first direction 218 (i.e., may be more easily flexed, bent, or deformed in this direction) than it has flexibility along the second direction 220 as well as a third axis (e.g., an out-of-plane axis) perpendicular to the first and second directions 218, 220. Accordingly, the first set of suspension elements 210a-210b may resist relative movement between the intermediate carrier 206 and the stationary base 204 in any direction other than the first direction 218.

Similarly, in some variations, the inner carrier 208 is controllable to move in only a single direction relative to the intermediate carrier 206. In other words, the electromagnetic actuator arrangement 200 may be unable to controllably move the inner carrier 208 relative to the intermediate carrier 206 in directions other than the second direction 220 (e.g., the inner carrier 208 only includes actuators that are configured to move the inner carrier 208 relative to the intermediate carrier 206 in the second direction 220). In instances where the electromagnetic actuator arrangement 200 includes a planar nested carrier, the inner carrier 208 may be controllable to move only in a second planar direction (i.e., the second direction 220) within the plane of the nested carrier.

In these variations, the second set of suspension elements 212a-212b may be configured to prioritize relative movement between the intermediate carrier 206 and the inner carrier 208 along the second direction 220. For example, the second set of suspension elements 212a-212b may each have greater flexibility along the second direction 220 than it has flexibility along the first direction 218 as well as the third axis perpendicular to the first and second directions 218, 220. Accordingly, the second set of suspension elements 212a-212b may resist relative movement between the intermediate carrier 206 and the inner carrier 208 in any direction other than the second direction 220.

When a set of actuators is described herein as being mounted to a given component (e.g., to an inner carrier or an intermediate carrier), it should be appreciated that the set of actuators may include a single actuator or multiple actuators. In instances where a set of actuators includes multiple actuators, the multiple actuators may be used to provide a larger Lorentz force than can be achieved by a single actuator alone. Additionally or alternatively, the multiple actuators may be mounted to the carrier in a way such that the set of actuators does not inadvertently provide unwanted forces (e.g., rotational forces) to the carrier during movement of that carrier.

When an actuator is described herein as being “mounted to” a component (e.g., the inner carrier 208 or the intermediate career 206), it should be appreciated that only a portion of the actuator may be mounted to the carrier. For example, when an actuator is a VCM actuator that includes a coil and a magnet (though it should be appreciated that a given VCM actuator may include multiple coils that interact with a common magnet), only one of the coil and magnet needs to be mounted to the carrier (in which case that VCM actuator is considered to be mounted to the carrier). For example, FIG. 2B shows a first variation 222 of a cross-sectional side view of the electromagnetic actuator assembly 200 of FIG. 2A (taken along line 2B-2B). In the variation 222 shown in FIG. 2B, each of the second set of actuators 216a, 216b includes a magnet and a coil. Specifically, the first set of actuators 216a-216b includes a first actuator 216a having a first magnet 224a and a first coil 226a and a second actuator 216b having a second magnet 224b and a second coil 226b. In the variation shown in FIG. 2B, both the first magnet 224a and the second magnet 224b are mounted to the inner carrier 208 (thereby mounting the first and second actuators 216a, 216b to the inner carrier 208). The first coil 226a and the second coil 226b are mounted to a stationary component within the electromagnetic actuator assembly 200 (e.g., to a mounting structure that is fixed relative to the stationary base 204) such that first coil 226a is positioned within a magnetic field 228a of the first magnet 224a and the second coil 226b is positioned within a magnetic field 228b of the second magnet 224b. When current is run through either or both of the coils 226a, 226b, a corresponding Lorentz force will be generated along the second direction 220.

While the first and second magnets 224a, 224b are shown in FIG. 2B as being mounted to the inner carrier 208, in other variations one or both of the first and second coils 226a, 226b may instead be mounted to the inner carrier 208. For example, FIG. 2C shows a second variation 224 of a cross-sectional side view of the electromagnetic actuator assembly 200 of FIG. 2A (also taken along line 2B-2B). The first and second actuators 216a, 216b may be the same as the variation shown in FIG. 2B, except that the first and second coils 226a, 226b are instead mounted to the inner carrier 208, and the first and second magnets 224a, 224b are mounted to a stationary component within the electromagnetic actuator assembly 200.

In instances where a coil of an actuator is mounted to a carrier, the electromagnetic actuators described herein may be configured to route current to the coil to facilitate operation of the actuator. In some variations one or more electrical traces may be carried by the nested carrier to reach coils mounted thereon. For example, to power a coil mounted to the intermediate carrier 206, one or more electrical traces may be carried by the stationary base 204, along one or more of the first set of suspension elements 210a-210b, and to the intermediate carrier 206. Traces may further extend along the second set of suspension elements 212a-212b to reach coils mounted to the inner carrier 208. In other variations, flexible cables or sheets (such as a ribbon cable or the like) may provide electrical connections to one or both of the carriers.

In some variations, a coil or magnet may be mounted directly to a carrier (such as the first and second magnets 224a, 224b in the variation 222 shown in FIG. 2B). In other variations, the coil or magnet may be mounted indirectly to a carrier via an intervening structure. For example, in FIG. 2C, the variation 232 of the electromagnetic actuator assembly 200 may include one or more mounting structures (e.g., a first mounting structure 234a connecting the first coil 226a to the inner carrier 208 and a second mounting structure 234b connecting the second coil 226b to the inner carrier 208). These mounting structures may allow for a physical connection between a given carrier and an actuator (and thus allowing the actuator to apply moving forces to the carrier), while providing flexibility in determining the relative sizes of the actuator and the carrier.

For example, a mounting structure may extend laterally (e.g., along the first and/or second directions 218, 210) past a peripheral edge of the carrier, which may allow the portion of the actuator mounted to the carrier to also extend laterally past the peripheral edge of the carrier. In the variation 232 shown in FIG. 2C, the first coil 226a is positioned such that is extends laterally past a peripheral edge of the inner carrier 208, such that at least a portion of the first coil 226a is suspended above a portion of suspension element 212a. In these instances, it may not be necessary for a surface (e.g., a top surface or a bottom surface) of the inner carrier 208 to be sized to accommodate the entire first coil 226a, so long as the inner carrier 208 has sufficient space to connect to the first mounting structure 234a. Accordingly, the size of the inner carrier 208 may be reduced as compared to instances in which one or more actuators are mounted directly to the inner carrier 208. Similar principles may be additionally or alternatively applied to the intermediate carrier 206 and any actuators mounted thereto.

Returning to FIG. 2A, by decoupling motion of the optical element 202 between the inner carrier 208 and the intermediate carrier 206, the electromagnetic actuator arrangement can be designed to achieve different movement capabilities and operating characteristics in each of the movement axes. For example, movement of the optical component 202 along the second direction 220 may consume less power than a similar movement of the optical component 202 along the first direction 218. Specifically, movement of optical component 202 along the second direction 220 may be achieved by movement of the inner carrier 218 and any components carried by the inner carrier 208 (including the optical element 202 and the components of the second set of actuators 216a-216b that are mounted to the inner carrier 208). Conversely, movement of the optical component 202 along the first direction 218 requires movement of these components as well as the intermediate carrier 206 and any components carried by the intermediate carrier 206 (including the components of the first set of actuators 214a-214b that are mounted to the intermediate carrier 206). Accordingly, because a larger amount of mass is moved when moving the optical component 202 in the first direction 218 as compared to the same increment of movement in the second direction 220, the electromagnetic actuator arrangement 200 may be specifically configured to accommodate movement of this mass, which may impact the stiffness and/or movement dynamics of the suspension elements. Overall, the electromagnetic actuator arrangement 220 may require more power when moving the optical component 202 in the first direction 218.

Because the inner carrier 208 may only be moved relative to the intermediate carrier 206 along one direction (i.e., the second direction 220), it may include fewer actuators (and thus carry less mass, assuming similarly designed components of each arrangement) than the carrier 106 of FIG. 1. As compared to similar corresponding movements of the carrier 106 of FIG. 1, it may require less power to move the inner carrier 208 in the second direction 220 and more power to move the inner carrier 208 in the first direction 218. Accordingly, the nested carrier may be especially useful in instances where there are different requirements for moving the optical component 202 in different directions. For example, if optical component 202 is incorporated into an optical system where the optical component 202 is moved more frequently in the second direction 220 than in the first direction 218, operation of the electromagnetic actuator arrangement 200 of FIG. 2A may consume less power overall as compared to similar operation using the electromagnetic actuator arrangement 100 of FIG. 1.

Additionally, when movement is decoupled between the intermediate carrier 206 and the inner carrier 208, each movement direction may be tuned differently to achieve different mass, stiffness, resonance, and/or stroke range in that direction. For example, because the inner carrier 208 carries less weight than the intermediate carrier 206, the second set of suspension elements 212a-212b may be designed with lower stiffness than the first set of suspension elements 210a-210b, which may contribute to the power savings in moving the optical component 202 in the second direction 220 as compared to moving the optical component 202 in the first direction 218.

For example, the design of the first set of suspension elements 210a-210b (e.g., the number, shape, and/or stiffness of the individual suspension elements) may vary from the design of the second set of suspension elements 212a-212b to impart different movement dynamics between the first and second directions 218, 220, which may allow for tuning to account for different movement requirements in the first and second directions 216, 218. For example, the nested carrier of FIG. 2A may be configured such that the inner carrier 208 has a longer stroke range in the second direction 220 than it has in the first direction 218. In other words, the inner carrier 208 may be moveable in the second direction 220 relative to the intermediate carrier 206 along a greater a range of distances than the intermediate carrier 206 is moveable in the first direction 218 relative to the stationary base 204. This may be useful in optical systems where there are different requirements for stroke ranges of the optical element 202 along different axes.

It should be appreciated that the optical component 202 is positioned to receive light within an optical system, and may include any structure capable of measuring, redirecting, or otherwise modifying light it receives in the optical system. For example, in some variations, the optical component 202 is an image sensor that is configured to measure light incident on the image sensor. In these variations, the image sensor may output one or more signals that represent the amount of light collected in different regions of the image sensor. In other variations, the optical component 202 includes a lens element (or a stack of lens elements) that is configured to reshape (e.g., change the convergence/divergence) or redirect a light beam received by the lens element.

In still other variations, the optical component 202 may comprise a diffuser. The diffuser may be positioned within an optical system to diffuse an incoming light beam. The nested carriers of the electromagnetic actuator arrangements described herein may have particular utility when used to move a diffuser, as a diffuser may have a relatively small mass as compared to other optical components such as image sensors and lens elements. Specifically, heavier optical components may be the dominant factor in determining the mass of the inner carrier 208, and thus may not see as much power savings in terms of percentage change. Conversely, as the weight of the optical component 202 decreases, the weight of actuator components (e.g., the coil(s) or magnet(s) thereof) may become the dominant mass factor, and thus the use of a nested carrier (as opposed to the electromagnetic actuator arrangement 100 of FIG. 1) will see a larger benefit from de-coupling the movement between different directions.

In some variations, the inner carrier 208 may define an aperture extending therethrough (such as aperture 230 in FIGS. 2B and 2C), which may allow light to pass through the inner carrier 208 during operation of an optical system incorporating the electromagnetic architecture arrangement 200. For example, in instances where the optical component 202 is a diffuser or a lens element, the optical component 202 may be positioned over (or at least partially within) the aperture 230 such that the optical component modifies light that passes through the aperture 230. In instances where the optical component 202 is an image sensor, the image sensor may be mounted to the inner carrier 208 such that light received and measured by the image sensor first passes through the aperture 230.

While the electromagnetic actuator arrangement 200 of FIG. 2A is shown as moving a single optical component 202, in other variations the electromagnetic actuator arrangements described herein may be configured to move multiple optical components. For example, in the variation shown in FIG. 2A, the inner carrier 208 may carry multiple optical components, including optical component 202. In these instances, movement of the inner carrier 208 (e.g., relative to intermediate carrier 206 in the second direction 220 or relative to the stationary base 204 in the first direction 218) will move the multiple optical components. In this way, the multiple optical components are moved together, and may thereby maintain a fixed relationship when moving relative to the stationary base.

In other variations, two optical components may be independently moveable along an axis of the electromagnetic actuator arrangement. For example, FIG. 2D shows a top view of an example of an electromagnetic actuator arrangement 240 that includes a nested carrier that is configured to independently move both a first optical element 242a and a second optical element 242b relative to a stationary base 244. Specifically, the electromagnetic actuator arrangement 240 includes a nested carrier that includes the stationary base 244, an intermediate carrier 246, a first inner carrier 248a, and a second inner carrier 248b. The nested carrier may be planar, and the electromagnetic actuator arrangement 240 may be controllable to move the first and second optical components 242a, 242b in multiple planar directions within this plane. While shown in FIG. 2D as including two inner carriers 248a, 248b, it should be appreciated that the principles described herein may be applied to three or more inner carriers moveably connected to the inner carrier 246, or two or more intermediate carriers (each moveably connected to one or more inner carriers).

The nested carrier includes a first set of suspension elements 250a-250b, a second set of suspension elements 252a-252b, and a third set of suspension elements 254a-254b. The intermediate carrier 246 is moveably connected to the stationary base 244 via the first set of suspension elements 250a-250b, and may be controllable to move relative to the stationary base 244 along a first direction 218. Specifically, a first set of actuators 258a-258b is mounted to the intermediate carrier 246, and each of these actuators is controllable (alone or collectively) to apply a force to the intermediate carrier 246 relative to the stationary base 244 along the first direction 218. The stationary base 244, the intermediate carrier 246, the first set of suspension elements 250a-250b, and the first set of actuators 258a-258b may be configured in any manner as described above with respect to the corresponding components of the electromagnetic actuator arrangement 200 of FIGS. 2A-2C.

The first inner carrier 248a is moveably connected to the intermediate carrier 246 by the second set of suspension elements 252a-252b. Similarly, the second inner carrier 248b is moveably connected to the intermediate carrier 246 by the third set of suspension elements 254a-254b. In some variations, the nested carrier is monolithic. For example, the stationary base 244, the intermediate carrier 246, the first and second inner carriers 248a, 248b, and the first, second, and third sets of suspension elements 250a-250b, 252a-252b, 254a-254b may be formed from a single sheet of material (e.g., a metal) material, in which some of the material is removed from the sheet to define the various components of the nested carrier.

The first and second inner carriers 248a, 248b are independently moveable relative to the intermediate carrier 246 (and thereby the stationary base 244) along a second direction 220, and each may be configured and moved in any manner as described with respect to the inner carrier 208 of FIGS. 2A-2C. Specifically, a second set of actuators 260a-260b is mounted to the first inner carrier 248a, and each of these actuators is controllable (alone or collectively) to apply a force to the first inner carrier 248a relative to the intermediate carrier 246 along the second direction 220. Similarly, a third set of actuators 262a-262b is mounted to the second inner carrier 248b, and each of these actuators is controllable (alone or collectively) to apply a force to the second inner carrier 248b relative to the intermediate carrier 246 along the second direction 220.

The first optical component 242a may be carried by (e.g., mounted to) the first inner carrier 248a, such that movement of the first inner carrier 248a relative to the stationary base 244 also moves the first optical component 242a relative to the stationary base 244. The second optical component 242b may be carried by (e.g., mounted to) the second inner carrier 248b, such that movement of the second inner carrier 248b relative to the stationary base 244 also moves the second optical component 248b relative to the stationary base 244. Movement of the intermediate carrier 246 relative to the stationary base 244 in the first direction will also move both the first and second inner carriers 248a, 248b in that direction, and thus the first and second optical components 242a, 242b may be moved together and thereby maintain a fixed relationship along the first direction 218. Along the second direction 220, however, the first optical component 242a may be moved (by virtue of relative movement between the first inner carrier 248a and the intermediate carrier 246) independently of movement of the second optical component 242b (by virtue of relative movement between the second inner carrier 248b and the intermediate carrier 246).

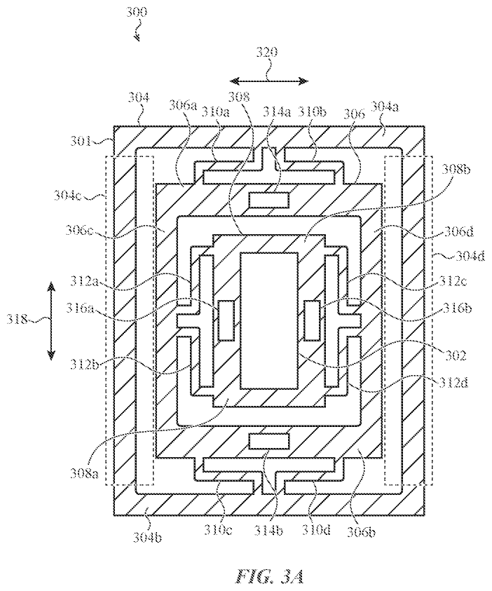

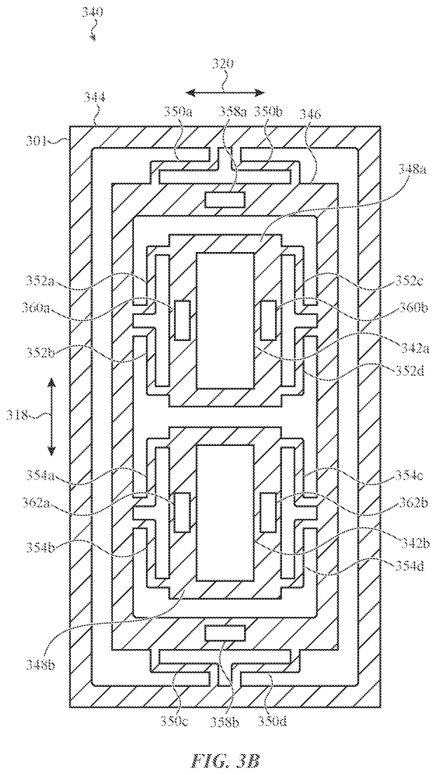

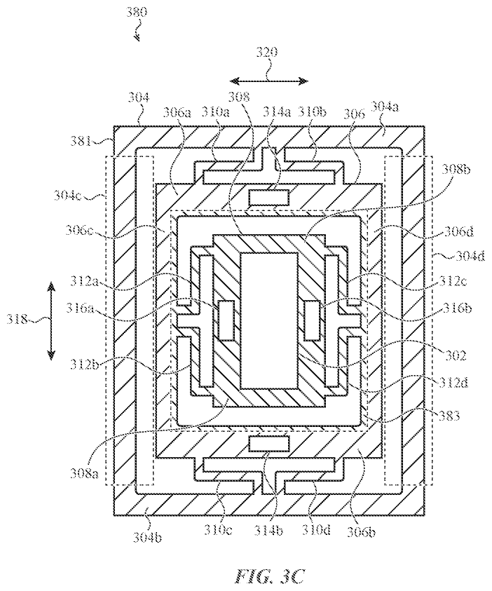

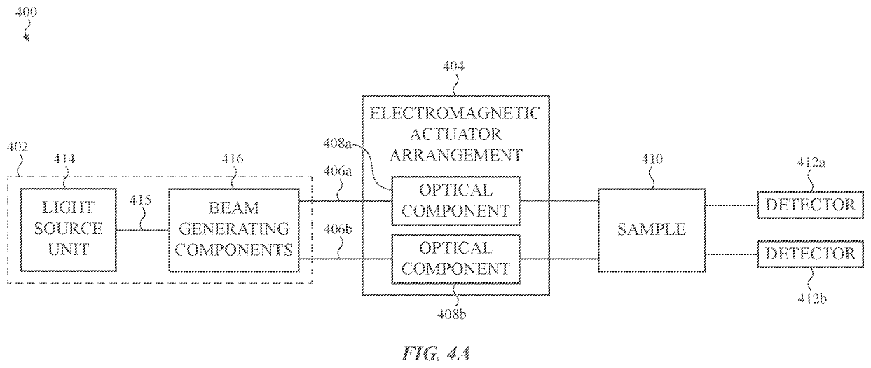

As mentioned herein, the nested carriers of the electromagnetic arrangement structures may be at least partially formed from one or more planar sheets of material. FIG. 3A shows a top view of a variation of an electromagnet actuator arrangement 300 that includes a nested carrier formed from a planar sheet 301 (with the portions formed from the planar sheet 301 shown with cross-hatching) and is configured to move an optical component 302 relative to a stationary base 304. The nested carrier includes an intermediate carrier 306 that is moveably connected to the stationary base 304 by a first set of suspension elements 310a-310d, and an inner carrier 308 that is moveably connected to the intermediate carrier 306 by a second set of suspension elements 312a-312d. The optical component 302 may be carried by (e.g., mounted to) the inner carrier 308, such that movement of the inner carrier 308 also moves the optical component 302.

The inner carrier 308 (and thereby the optical component 302) is moveable within the plane of the sheet 301 along two axes (i.e., a first planar direction 318 and a second planar direction 320 perpendicular to the first planar direction 318). Specifically, the intermediate carrier 306 includes a first set of actuators 314a-314b that is mounted to the intermediate carrier 306 and controls relative movement between the intermediate carrier 306 and the stationary base 304 in the first planar direction 318, such as described with respect to the intermediate carrier 206 of FIG. 2A. This relative movement also controls the relative movement between the inner carrier 308 (and thereby the optical component 302) and the stationary base 304 along the first planar direction 318. In some variations, the intermediate carrier 306 is only controllable to move in the first planar direction 318. The inner carrier 308 includes a second set of actuators 316a-316b that is mounted to the inner carrier 308 and controls relative movement between the inner carrier 308 and the intermediate carrier 306 along the second planar direction 320, such as described herein with respect to the inner carrier 206 of FIG. 2A.

In some variations, the stationary base 304 is configured to surround the intermediate carrier 306. Specifically, the stationary base 304 includes a first side 304a that is positioned opposite a second side 304b such that the intermediate carrier 306 is positioned between first and second sides 304a, 304b. The stationary base 304 may further include a third side 304c and a fourth side 304d, each of which connects the first side 304a to the second side 304b (and thereby surrounds the intermediate carrier 306). It should be appreciated, however, that the third side 304c and/or fourth side 304d of the stationary base 304 may be omitted, which may reduce the overall footprint of the electromagnetic actuator arrangement 300 along the second planar direction 320.

In the variation shown in FIG. 3A, the first set of suspension elements 310a-310d is configured as a set of flexures formed from corresponding portions of the sheet 301. The first set of suspension elements 310a-310d may be configured to facilitate movement of the intermediate carrier 306 along the first planar direction 318 while restricting movement of the intermediate carrier 306 along the second planar direction 320. For example, the first set of suspension elements 310a-310d may have lower in-plane stiffness in the first planar direction 318 than in the second planar direction 320, and thus will more easily flex to accommodate movement of the intermediate carrier 306 in the first planar direction 318.

The first set of suspension elements 310a-310d includes at least one suspension element (i.e., a first group) connecting the first side 304a of the stationary base 304 to the intermediate carrier 306 and at least one suspension element (i.e., a second group) connecting the second side 304b of the stationary base 304 to the intermediate carrier 306. For example, in the variation shown in FIG. 3A, the first group includes first and second suspension elements 310a, 310b that connect the first side 304a of the stationary base 304 to the intermediate carrier 306, and the second group includes third and fourth suspension elements 310c, 310d that connect the second side 304b of the stationary base 304 to the intermediate carrier 306. It should be appreciated that these suspension elements 310a-310d may be connected to additional or different sides of the stationary base if so desired. Additionally, the first group and second group may have any suitable number of suspension elements (e.g., a single suspension element, or two, three, or four or more suspension elements), and that the first and second groups need not include the same number of suspension elements.

In some variations, the first and second groups of the first set of suspension elements 310a-310d may each be symmetric. Specifically, either or both of the first and second groups may have an axis of symmetry that is parallel to the first planar direction 318. For example, in the variation shown in FIG. 3A, the first suspension element 310a is a mirror image of the second suspension element 310b, and the third suspension element 310c is a mirror image of the fourth suspension element 310d. Additionally or alternatively, either or both of the first and second groups may include a flexure that has a symmetric shape with an axis of symmetry that is parallel to the first planar direction 318. Configuring the first and/or second groups of the first set of suspensions elements 310a-310d to be symmetric may help to reduce unintentional torsion of intermediate carrier 306 during movement along the first planar direction 318.

Additionally or alternatively, some or all of the first set of suspension elements 310a-310d may be positioned to connect adjacent corresponding sides of the stationary base 304 and the intermediate carrier 306. For example, in the variation shown in FIG. 3A, the first group of the first set of suspension elements 310a-310d (i.e., the first suspension element 310a and the second suspension element 310b) may connect the first side 304a of the stationary base 304 to the corresponding adjacent side of the intermediate carrier 306 (i.e., a first side 306a of the intermediate carrier 306 that is closest to and facing the first side 304a of the stationary base 304). In this way, the suspension elements of the first group (e.g., the first and second suspension elements 310a, 310b) are positioned entirely between the first side 304a of the stationary base 304 and the first side 306a of the intermediate carrier 306.

Similarly, the second group of the first set of suspension elements 310a-310d (i.e., the third suspension element 310c and the fourth suspension element 310d) may connect the second side 304b of the stationary base 304 to the corresponding adjacent side of the intermediate carrier 306 (i.e., a second side 306b of the intermediate carrier 306 that is closest to and facing the second side 304b of the stationary base 304). In this way, the suspension elements of the second group (e.g., the third and fourth suspension elements 310c, 310d) are positioned entirely between the second side 304b of the stationary base 304 and the second side 306b of the intermediate carrier 306.

The intermediate carrier 306 may include third and fourth sides 306c, 306d that each extend between the first and second sides 306a, 306b of the intermediate carrier 306. When each suspension element of the first set of suspension elements 310a-310d only connects to either the first or second side 306a, 306b of the intermediate carrier 306 as shown in FIG. 3A, there may be no intervening suspension elements between the third side 306c of the intermediate carrier 306 and the third side 304c of the stationary base 304, and no intervening suspension elements between the fourth side 306d of the intermediate carrier 306 and the fourth side 304d of the stationary base 304. This may allow for a more compact geometry of the electromagnetic actuator arrangement 300 along the second planar direction 320.

In the variation shown in FIG. 3A, the second set of suspension elements 312a-312d is configured as a set of flexures formed from corresponding portions of the sheet 301. The second set of suspension elements 312a-312d may be configured to facilitate relative movement between the inner carrier 308 and the intermediate carrier 306 along the second planar direction 320 while restricting relative movement between the inner carrier 308 and the intermediate carrier 306 along the first planar direction 318. For example, the second set of suspension elements 312a-312d may have lower in-plane stiffness in the second planar direction 320 than in the first planar direction 318, and thus will more easily flex to accommodate movement of the inner carrier 308 in the second planar direction 320.

The second set of suspension elements 312a-312d includes at least one suspension element (i.e., a first group) connecting the third side 306c of the intermediate carrier 306 to the inner carrier 308 and at least one suspension element (i.e., a second group) connecting the fourth side 306d of the intermediate carrier 306 to the inner carrier 308. For example, in the variation shown in FIG. 3A, the first group includes first and second suspension elements 312a, 312b that connect the third side 306c of the intermediate carrier 306 to the inner carrier 308, and the second group includes third and fourth suspension elements 312c, 312d that connect the fourth side 304d of the intermediate carrier 306 to the inner carrier 308. It should be appreciated that the first group and second group of the second set of suspension elements 312a-312d may have any suitable number of suspension elements (e.g., a single suspension element, or two, three, or four or more suspension elements), and that the first and second groups need not include the same number of suspension elements.

In some variations, the first and second groups of the second set of suspension elements 312a-312d may each be symmetric. Specifically, either or both of the first and second groups may have an axis of symmetry that is parallel to the second planar direction 320. For example, in the variation shown in FIG. 3A, the first suspension element 312a is a mirror image of the second suspension element 312b, and the third suspension element 312c is a mirror image of the fourth suspension element 312d. Additionally or alternatively, either or both of the first and second groups may include a flexure that has a symmetric shape with an axis of symmetry that is parallel to the second planar direction 320. This may help to reduce unintentional torsion of inner carrier 308 as it moves relative to the intermediate carrier 306 along the second planar direction 320.

Additionally or alternatively, some or all of the second set of suspension elements 312a-312d may be positioned to connect adjacent corresponding sides of the inner carrier 308 and the intermediate carrier 306. For example, in the variation shown in FIG. 3A, the first group of the second set of suspension elements 312a-312d (i.e., the first suspension element 312a and the second suspension element 312b) may connect the third side 306c of the intermediate carrier 306 to the corresponding adjacent side of the inner carrier 308 (i.e., a first side 308a of the inner carrier 308 that is closest to and facing the third side 306c of the intermediate carrier 306). In this way, the suspension elements of the first group (e.g., the first and second suspension elements 312a, 312b) are positioned entirely between the third side 306c of the intermediate carrier 306 and the first side 308a of the inner carrier 308.

Similarly, the second group of the second set of suspension elements 312a-312d (i.e., the third suspension element 312c and the fourth suspension element 312d) may connect the fourth side 306d of the intermediate carrier 306 to the corresponding adjacent side of the inner carrier 308 (i.e., a second side 308b of the inner carrier 308 that is closest to and facing the fourth side 304d of the intermediate carrier 306). In this way, the suspension elements of the second group (e.g., the third and fourth suspension elements 312c, 312d) are positioned entirely between the fourth side 306d of the intermediate carrier 306 and the second side 308b of the inner carrier 308. In this way, there may be no intervening suspension elements between the first side 306a of the intermediate carrier 306 and the inner carrier 308, and no intervening suspension elements between the second side 306b of the intermediate carrier 306 and the inner carrier 308. This may allow for a more compact geometry of the electromagnetic actuator arrangement 300 along the first planar direction 318.

The principles of the electromagnetic actuator arrangement 300 of FIG. 3A may be extended to embodiments of nested carriers that include multiple inner carriers. For example, FIG. 3B shows a top view of a variation of an electromagnet actuator arrangement 340 that includes a nested carrier formed from a planar sheet 301 (with the portions formed from the planar sheet 301 shown with cross-hatching) and is configured to independently move a first optical component 342a and a second optical component 342b in multiple planar directions relative to a stationary base 344. Specifically, the nested carrier of the electromagnetic actuator arrangement 340 includes an intermediate carrier 346, a first inner carrier 348a, and a second inner carrier 348b.

The nested carrier further includes a first set of suspension elements 350a-350d, a second set of suspension elements 352a-352d, and a third set of suspension elements 354a-354d. The intermediate carrier 346 is moveably connected to the stationary base 344 via the first set of suspension elements 350a-350d, and may be controllable to move relative to the stationary base 344 along a first planar direction 318. Specifically, a first set of actuators 358a-358b is mounted to the intermediate carrier 346, and each of these actuators is controllable (alone or collectively) to apply a force to the intermediate carrier 346 relative to the stationary base 344 along the first planar direction 318. The stationary base 344, the intermediate carrier 346, the first set of suspension elements 350a-350d, and the first set of actuators 358a-358b may be configured in any manner as described above with respect to the corresponding components of the electromagnetic actuator arrangement 300 of FIG. 3A.

The first inner carrier 348a is moveably connected to the intermediate carrier 346 by the second set of suspension elements 352a-352d. Similarly, the second inner carrier 348b is moveably connected to the intermediate carrier 346 by the third set of suspension elements 354a-354d. The first and second inner carriers 348a, 348b are independently moveable relative to the intermediate carrier 346 (and thereby the stationary base 344) along a second planar direction 320. Specifically, a second set of actuators 360a-360b is mounted to the first inner carrier 348a, and each of these actuators is controllable (alone or collectively) to apply a force to the first inner carrier 348a relative to the intermediate carrier 346 along the second planar direction 320. Similarly, a third set of actuators 362a-362b is mounted to the second inner carrier 348b, and each of these actuators is controllable (alone or collectively) to apply a force to the second inner carrier 348b relative to the intermediate carrier 346 along the second planar direction 320. It should be appreciated that each inner carrier, as well as its corresponding set of suspension elements, may be configured in any manner as described herein with respect to the inner carrier 308 and the second set of suspension elements 312a-312b of FIG. 3A.

It should be appreciated that the sheet 301 used to form the nested carriers of FIGS. 3A and 3B may be a single layer structure, or may be a multi-layer structure in which multiple layers (of the same or different materials) may be bonded or otherwise attached to form the sheet. In other instances, multiple different sheets may be used to form different portions of the nested carrier. For example, FIG. 3C shows an example of an electromagnetic actuator arrangement 380 that may be identical to and labeled the same as the electromagnetic actuator arrangement 300 of FIG. 3A, except that the nested carrier is made from multiple sheets (e.g., a first planar sheet 381 and a second planar sheet 383) instead of the single planar sheet 301 of FIG. 3A. In this example, the first planar sheet 381 forms the stationary base 304, the first set of suspension elements 310a-310d, and a first portion of the intermediate carrier 306, and the second planar sheet 383 forms a second portion of the intermediate carrier 306, the second set of suspension elements 312a-312d, and the inner carrier 308. This may allow for the first and second sets of suspension elements 310a-310d, 312a-312d to be formed from different materials, which may allow for further tuning of the movement dynamics between the first and second planar directions 318, 320. The first planar sheet 381 may be connected to the second planar sheet 383 in the intermediate carrier 381 (e.g., a portion of the first planar sheet 381 may overlap a corresponding portion of the second planar sheet 383 to facilitate bonding therebetween). The principle illustrated in FIG. 3C may be applied to the electromagnetic actuator arrangement 340 of FIG. 3B. For example, first planar sheet may form the stationary base 344 and a portion of the intermediate carrier 346, while a second planar sheet may form a second portion of the intermediate carrier 346 and both inner carriers 348a, 348b. Alternatively, the second planar sheet forms a second portion of the intermediate carrier 346 and the first inner carrier 348a, while a third planar sheet forms a third portion of the intermediate carrier 346 and the second inner carrier 348b.

The electromagnetic actuator arrangements described herein, including any of the electromagnetic actuator arrangements described with respect to FIGS. 2A-3C and 6A-6D, may be incorporated into an optical system in order to move an optical component within the optical system. For example, FIGS. 4A-4E show an example of a variation of an optical system 400 that is configured as an optical measurement system that is configured to measure one or more characteristics of objects or substances. Specifically, the optical system 400 may include a beam-generating assembly 402 and an electromagnetic actuator arrangement 404. The beam-generating assembly 402 is configured to generate a set of light beams 406a-406b and direct the set of light beams 406a-406b to the electromagnetic actuator arrangement 404. The electromagnetic actuator arrangement 404 includes a set of optical components 408a-408b, each of which is positioned to receive a corresponding light beam of the set of light beams 406a-406b.

Each of the set of optical components 408a-408b is independently moveable, using the electromagnetic actuator arrangement 404, to diffuse, redirect, or otherwise modify (depending on the selection of the optical components 408a-408b) the corresponding light beam received by the optical component. The optical system 400 is configured to direct the set of light beams 406a-406b from the set of optical components 408a-408b to a sample 410. The set of light beams 406a-406b may interact with corresponding portions of the sample 410 and return to the optical system (e.g., via scattering and/or reflection). Accordingly, the optical system 400 is further configured to collect light returned from the sample 410, and may measure the collected light using a set of detector groups 412a-412b. The amount of light from the set of light beams 406a-406b that is returned to the optical system 400 may depend on the properties of the sample 410, and thus the light measured by the set of detector groups 412a-412b may be analyzed to determine one or more properties of the sample 410. The optical measurement systems may facilitate a wide range of analytical techniques as would be readily understood by one of ordinary skill in the art, and thus individual techniques for deriving properties from a sample will not be discussed herein.

While the beam-generating assembly 402 is shown in FIG. 4A as generating two light beams (i.e., a first light beam 406a and a second light beam 406b), it should be appreciated that the beam-generating assembly 402 may in other instances generate a set of light beams that includes a single light beam that is received by the electromagnetic actuator arrangement 404 (such as in instances where the electromagnetic actuator arrangement 404 has a single moveable inner carrier) or more than two light beams that are received by the electromagnetic actuator arrangement 404. Additionally, while each optical component of the set of optical components 408a-408b is shown in FIG. 4A as receiving a single light beam, in other instances one or more of these optical components may receive multiple different light beams.

When the beam-generating assembly 402 is configured to generate multiple different light beams, it should be appreciated that different light beams may be generated simultaneously or sequentially, depending on the design and intended operation of the optical system 400. For example, the beam-generating assembly 402 may be configured to generate multiple light beams simultaneously, such that a given optical component of the set of optical components 408a-408b receives multiple light beams simultaneously and/or multiple optical components of the set of optical components 408a-408b each simultaneously receive a corresponding light beam. Additionally or alternatively, the beam-generating assembly 402 may be capable of generating different light beams at different times. In one example, the beam-generating assembly 402 may be able to generate the first beam 406a and the second light beam 406b independently, such that the first beam 406a may be generated without also needing to generate the second light beam 406b, and vice versa. In this way, the beam-generating assembly 402 and the overall optical system 400 may have flexibility in when it generates and directs different light beams to the electromagnetic actuator arrangement 404.

The beam-generating assembly 402 may generate the set of light beams 406a-406b in any suitable manner. For example, in the variation shown in FIG. 4A, the beam-generating assembly 402 includes a light source unit 414 that is configured to generate light, and one or more beam generating components 416 that are configured to shape the light from the light source unit 414 into the set of light beams 406a-406b. Specifically, the light source unit 414 includes a set of light sources (not shown), each of which is selectively operable to emit light at a corresponding set of wavelengths. Each light source may be any component capable of generating light at one or more particular wavelengths, such as a light-emitting diode or a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (i.e., the light source may be controlled to output different wavelengths at different times). The set of light sources may include any suitable combination of light sources, and collectively may be operated to generate light at any of a plurality of different wavelengths. In this way, the each of the set of light beams 406a-406b may be generated to include light of different wavelengths (or different sets of wavelengths) at different times if so desired.

The light source unit 414 may include one or more outputs that are optically connected to the beam-generating components 416 to route light thereto. These one or more outputs collectively allow the light source unit 414 to route any of a plurality of different wavelengths to the one or more beam generating components 416. While a single output 415 is shown in FIG. 4A, it should be appreciated that in some variations the light source unit 414 includes a plurality of outputs. Each output 415 can route a corresponding set of wavelengths to the beam generating components 416 (e.g., in some instances, each output 415 from the light source unit 414 is routed to a different set of beam-generating components to create a different corresponding light beam). In some instances the light source unit 414 includes more light sources than outputs 415, in which case the light source unit 414 includes one or more multiplexers (not shown) to allow multiple light sources to contribute light to a single output 415. This allows the light source unit 414 to include several light sources (and thus be capable of generating several different wavelengths) while having a relatively small number of outputs 415.

In some variations, the optical system 400 includes a photonic integrated circuit (not shown), and the light source 414 may at least partially be integrated into the photonic integrated circuit. For example, some or all of the light sources, as well as any multiplexers of the light source unit 414 may be integrated into the photonic integrated circuit. In other instances some or all of the light sources generate light externally from the photonic integrated circuit and light from these light sources is coupled into the photonic integrated circuit.

Generally, the one or more beam-generating components 416 include any components between the light source unit 414 and the electromagnetic actuator arrangement 404 that assist with forming and shaping the light generated by the light source unit 414 into the set of light beams 406a-406b. In variations where the optical system 400 includes a photonic integrated circuit, a portion of the photonic integrated circuit may act as a beam-generating component. Specifically, one or more waveguides may receive light from the light source unit 414 (e.g., via an output 415 of the light source unit 414) and may route the light to one or more outcouplers (e.g., an edge coupler, a vertical output coupler, or the like) for launching light from the photonic integrated circuit. The photonic integrated circuit may further include additional components (e.g., polarizers, phase shifters, optical switches, or the like) for modifying or otherwise controlling light as it traverses the photonic integrated circuit. The one or more outcouplers may generate a single light beam, or may generate multiple light beams. Additionally or alternatively, the one or more beam-generating components 416 may include one or more lenses, mirrors, beam splitters, combinations thereof, or the like, which may act to shape, change the divergence of, redirect, or split light beams to direct the set of light beams 406a-406b to the set of optical components 408a-408b.

To measure light returned from the sample 410, each of the set of detector groups 412a-412b includes one or more sets of detector elements. Each set of detector elements includes at least one detector element, and each detector element is capable of generating a corresponding signal representative of light incident thereon. Individual detector elements can either be a standalone detector or a sensing element of a detector array (e.g., a photodiode of a photodiode array). It should be appreciated that different sensing elements of a single detector array may be associated with different detector groups 412a-412b. For example, a detector array may include a first subset of sensing elements associated with a first detector group 412a and a second subset of sensing elements associated with a second detector group 412b.

When the electromagnetic actuator arrangement 404 is configured to direct multiple light beams 406a-406b to the sample 410, the optical system 400 may be configured such that each detector group measures light from a different light beam. For example, when the first light beam 406a is introduced into the sample 410, the first detector group 412a measures a portion of the first light beam 406a that is returned to the optical system 400. Similarly, when the second light beam 406b is introduced into the sample 410, the second detector group 412b measures a portion of the second light beam 406b that is returned to the optical system 400. The optical system 400 may be configured such that the first detector group 412a only receives light corresponding to the first light beam 406a (i.e., with minimal or no light received and measured from the second light beam 406b), and the second detector group 412b only receives light corresponding to the second light beam 406b (i.e., with minimal or no light received and measured from the first light beam 406a).

In some variations, some or all of the set of optical components 408a-408b includes a diffuser. For example, FIG. 4B shows a perspective view of a portion of optical system 400 in which the first optical component 408a is a diffuser 420. In instances where the electromagnetic actuator arrangement 404 includes a second optical component 408b, this component may also be a diffuser, or in other instances may be a different optical components such as a lens, image sensor, or the like. The diffuser 420 will act to diffuse the incoming light beam 406a, which may act to increase the divergence of the light beam 406a as it passes through the diffuser 420.

Moving the diffuser 420 using the electromagnetic actuator arrangement 404 may act to reduce noise associated with measurements performed by the optical system 400. When the light source of the light source units described herein include coherent light sources, such as lasers, measurements performed using coherent illumination may be subject to coherent noise (also referred to herein as “speckle” noise). Specifically, the interference of coherent light as it scatters through a sample may result in spatial intensity variations of light received by a detector group that may reduce the signal-to-noise ratio of a given measurement. Movement of the diffuser 420 relative to the light beam 406a may cause the light beam 406a to be incident on a different portion of the diffuser 420, which may change the distribution of phase changes applied to the light beam 406a as it passes through the diffuser 420. Otherwise identical measurements performed using different diffuser 420 positions may have different speckle noise states. Accordingly, multiple measurements taken while the diffuser 420 is at different positions may be analyzed our otherwise combined to average out some of the speckle noise and thereby increase the SNR of measurements performed by the optical system 400, as will be described in more detail with respect to FIG. 5.

In some instances, it may be desirable to prioritize movement of the diffuser 420 in one planar direction over another planar direction. For example, in some variations a light beam may have a non-circular cross-sectional shape as it reaches the diffuser 420, such that its cross-sectional width along a first direction is less than its cross-sectional length along a second direction perpendicular to the first direction. For example, the first light beam 406a is depicted in FIG. 4B with a cross-sectional shape having a width W and a length L, where the length Lis longer than the width W. While shown as having a rectangular cross-sectional shape, the first light beam 406a in these instances may have any suitable non-circular cross-sectional shape (e.g., an oval, a rounded rectangle, or the like) in which the length L represents its longest dimension. The width W represents the longest dimension of the light beam 406a in a direction perpendicular to the length L.

In some of these variations, it may be desirable to configure the optical system 400 such that relative movement between an inner carrier and an intermediate carrier of the electromagnetic actuator arrangement 404 occurs in a direction parallel to the length L of the first beam 406a. For example, FIGS. 4C-4E show a top view of a portion of the optical system 400 in which the electromagnetic actuator arrangement 404 is used to move the diffuser 420 in multiple lateral directions relative to the first beam 406a. For the purpose of illustration, the electromagnetic actuator arrangement 404 is shown with the same configuration as the electromagnetic actuator arrangement 200 of FIG. 2A, though it should be appreciated that any of the electromagnetic actuator arrangements described herein with respect to FIGS. 2A-3C and 6A-6D may be used to move the diffuser 420.

Specifically, FIG. 4C shows the electromagnetic actuator arrangement 404 in a rest state in which the inner carrier 208 is not actively being moved relative to the stationary base 204. In the rest state, the first beam 406a may pass through a first portion of the diffuser 420. The inner carrier 208 may be moved relative to intermediate carrier 206 along the second direction 220 using the second set of actuators 216a-216b, as shown in FIG. 4D, to move the diffuser 420 relative to the stationary base 404 along the second direction 220. This also shifts the portion of the diffuser 420 through which the first beam 406a passes from the first portion to a second portion. In the variation shown in FIGS. 4C-4E, the first beam 406a is oriented such that its cross-sectional length is aligned with (e.g., parallel to) the second direction 220. In these variations, movement of the inner carrier 206 along the second direction 220 moves the diffuser 420 along the cross-sectional length of the first beam 406a.

The intermediate carrier 206 may be moved relative to the stationary base 204 along the first direction 218 using the first set of actuators 214a-214b, as shown in FIG. 4E, which also moves the inner carrier 208 and the diffuser 420 relative the stationary base 204 along the first direction 218. This also shifts the portion of the diffuser 420 through which the first beam 406a passes from the first portion to a third portion. When the first beam 406a is oriented such that its cross-sectional length is aligned with (e.g., parallel to) the second direction 220 as shown in FIGS. 4C-4E, this movement of intermediate carrier 206 along the first direction 218 moves the diffuser 420 along the cross-sectional width of the first beam 406a. Depending on the design of the optical system 400, moving the diffuser 420 along the cross-sectional length of the first beam 406a may provide a greater reduction in speckle noise as compared to a similar movement along the cross-sectional width of the first beam 406a. Accordingly, it may provide a greater balance of power savings and noise reduction to move the diffuser 420 along the second direction 220, and thus it may be desirable to prioritize movement of the diffuser 420 along this direction during operation of the optical system.

For example, FIG. 5 shows a variation of a method 500 of performing a series of measurements using an optical system (such as the optical system 400 of FIGS. 4A-4E). The method 500 may be performed using any of the electromagnetic actuator arrangements described herein that include a nested carrier used to move one or more optical components. Specifically, the method 500 includes performing multiple measurements, such that an optical component of the electromagnetic actuator arrangement is moved between different measurements. The multiple measurements may be broken into one or more sets of measurements, wherein the optical component is fixed along a first direction during the measurements of each set.

An intermediate carrier of the nested actuator may be moved relative to a stationary base between multiple positions along a first direction, such as described in more detail herein. This also moves an optical component carried by an inner carrier between multiple positions along the first direction. At each of the positions along the first direction, the optical system may collect a series of measurements. Within each series of measurements, the optical system may move an inner carrier relative to the intermediate carrier between multiple positions along a second direction (different from, such as perpendicular to, the first direction). The optical system may perform an individual measurement at each of these positions along the second direction, and these individual measurements collectively form a set of measurements for a given position along the first direction. The sets of measurements performed at the different positions along the first direction may collectively form the series of measurements, which may be analyzed to determine one or more properties of a sample being measured.

Specifically, at step 502, the measurement system performs a set of measurements while an optical component (e.g., a first optical component in instances where the electromagnetic actuator arrangement is configured to move multiple different optical components) is fixed along a first direction. Within the set of measurements, the optical component may be moved between a set of different positions along a second direction different from (e.g., perpendicular to) the first direction. Initially, a measurement is performed while the optical component is in a first position at step 504. As an example in which the optical system 400 of FIGS. 4A-4E is used to perform the method 500, this measurement may be performed with the diffuser 420 (acting as the optical component) positioned as shown in FIG. 4C. A first light beam 406a may be passed through the diffuser 420 to the sample 410, and the first detector group 412a may measure a portion of the first light beam 406a that is returned to the optical system 400 from the sample 410.

At step 506, the optical system may determine whether a measurement has been taken at every position within the set of different positions along the second direction. If additional positions remain, at step 508 the electromagnetic actuator arrangement will move the optical component to a new position along the second direction (while maintaining its position along the first direction). For example, the optical system 400 may move the inner carrier 208 relative to the intermediate carrier 206 and the stationary base 204 along the second direction 220 to move the diffuser 420 in this manner, such as shown in FIG. 4D. With the optical component in the new position, the method 500 returns to step 504 at which point a new measurement will be performed using the optical component, except that the optical component is in a new position. This process may be repeated until a measurement is taken at each of the set of different positions along the second direction, thereby completing the set of measurements.

The optical system may similarly perform a set of measurements using the optical component at multiple different positions along the first direction. Specifically, at step 510 the optical system may determine whether a corresponding set of measurements has been collected for each of a set of different positions along the first direction. If additional positions remain, the electromagnetic actuator arrangement will move the optical component to a new position along the first direction. Specifically, at step 512 an intermediate carrier of the electromagnetic actuator arrangement will be moved relative to a stationary base, thereby moving the optical component. For example, the optical system 400 may move the intermediate carrier 206 relative to the stationary base 204 along the first direction 218, such as shown in FIG. 4E, to position the optical component at a new position along the first direction. The method returns to step 502, at which point it will take a subsequent set of measurements with the optical component fixed at a new position along the first direction. It should be appreciated that for each position along the first direction, the set of measurements collected at step 502 may utilize the same set of positions along the second direction or may instead use a new set of positions along the second direction. Collectively, the optical system may collect a plurality of sets of measurements, where each set of measurement corresponds to a position along the first direction and includes multiple measurements taken at different positions along the second direction.

Overall, the electromagnetic actuator arrangement may move the optical component a greater overall distance along the second direction that it does moving the optical component along the first direction. In instances where the electromagnetic actuator arrangement is configured to consume less power when moving the optical component a distance in the second direction compared to a similar distance in the first direction, this may result in overall power savings as the electromagnetic actuator arrangement is used to facilitate measurements performed in the method 500 of FIG. 5.

In variations where an optical system includes an electromagnetic actuator arrangement configured to independently move multiple optical components, the method 500 may also include capturing one or more sets of measurements using the second optical component. For example, at step 514, the measurement system performs a set of measurements while an additional optical component (e.g., a second optical component) is fixed along the first direction. Within the set of measurements, the additional optical component may be moved between a second set of different positions along the second direction. Initially, a measurement is performed while the optical component is in a first position at step 516. As an example in which the optical system 400 of FIG. 4A is used to perform the method 500, this measurement may be performed with a second diffuser (acting as the additional optical component) positioned at a first position (e.g., using an electromagnetic actuator arrangement such as described with respect to FIGS. 2D and 3B). A second light beam 406b may be passed through the second diffuser to the sample 410, and the second detector group 412b may measure a portion of the second light beam 406b that is returned to the optical system 400 from the sample 410.

At step 518, the optical system may determine whether a measurement has been taken using the additional optical component at every position within the second set of different positions along the second direction. If additional positions remain, at step 520 the electromagnetic actuator arrangement will move the additional optical component to a new position along the second direction (while maintaining its position along the first direction), such as described above with respect to step 502. With the additional optical component in the new position, the method 500 returns to step 516 at which point a new measurement will be performed using the optical component, except that the optical component is in a new position. This process may be repeated until a measurement is taken at each of the set of different positions along the second direction, thereby completing the set of measurements using the additional optical component. Multiple sets of measurements may be performed using the additional optical element at different positions along the first direction. For example, moving the intermediate carrier along the first direction may also move the additional optical component in this direction, such as described herein with respect to FIG. 4B.

It should be appreciated that the steps 502 and 514 may be performed at least partially concurrently, such that the optical system will collect both a first set of measurements using the first optical component and a second set of measurements using the second optical component before moving the intermediate carrier in step 512. Within these steps, however, individual measurements and/or movement of the optical components may be performed at any relative timing as may be desired depending on the specifications of the optical system. For example, in some instances the first optical component may be moved in step 508 while a measurement is being performed using the second optical component in step 516 (and vice versa). This may be advantageous in instances where only one optical component receives a corresponding light beam at a time. For example, rather than splitting light between two beams at the same time, the optical system 400 may instead be configured route all of the light to either the first beam 406a or the second beam 406b, thereby causing the measurements at step 504 to be performed sequentially with the measurements at step 516. By moving the first optical component while the second optical component is being used in a measurement (and thus no light is being routed to the first optical component), the position of the first optical component may be settled before starting its next measurement. This may reduce the amount of downtime that might otherwise be required to set the position of a given optical component before initiating a measurement.

It should be appreciated that the method depicted in FIG. 5 is just one example of a method by which the electromagnetic actuator arrangements described herein may be operated, and that the electromagnetic actuator arrangements described herein with respect to FIGS. 2A-4E may additionally or alternatively be operated under different movement techniques. For example, an electromagnetic actuator arrangement as described herein may be operated such that an inner carrier of nested carrier moves simultaneously along multiple axes (e.g., the inner carrier may be moved in one direction relative to an intermediate carrier concurrently with the intermediate carrier moving in a different direction relative to a stationary base).

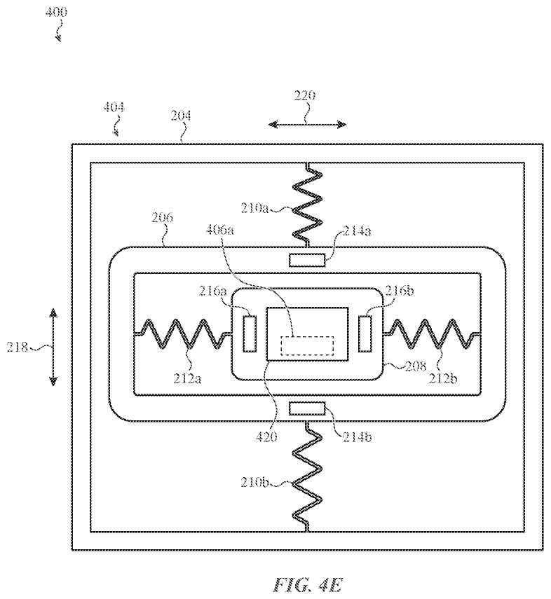

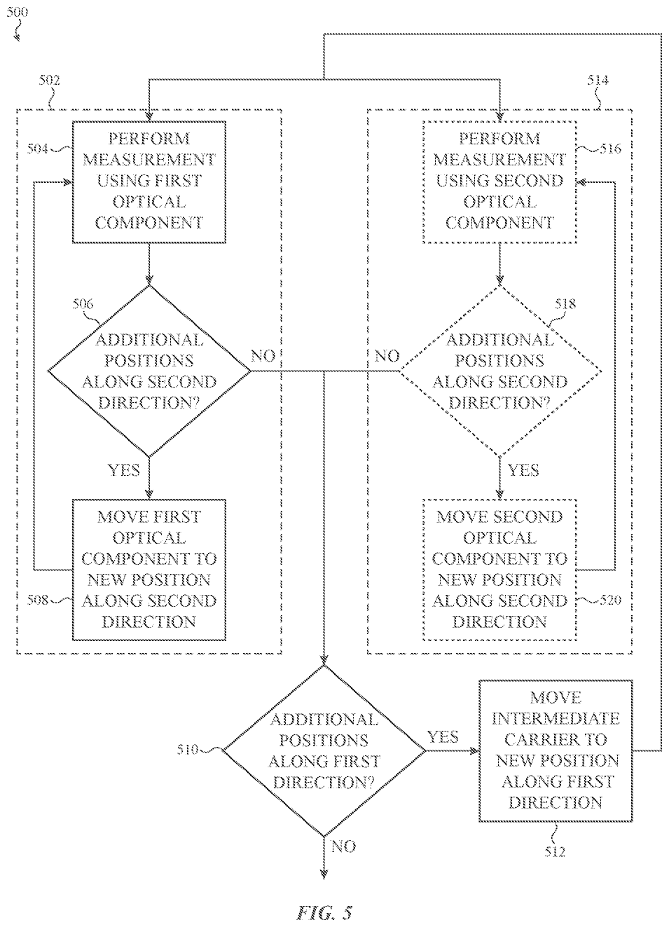

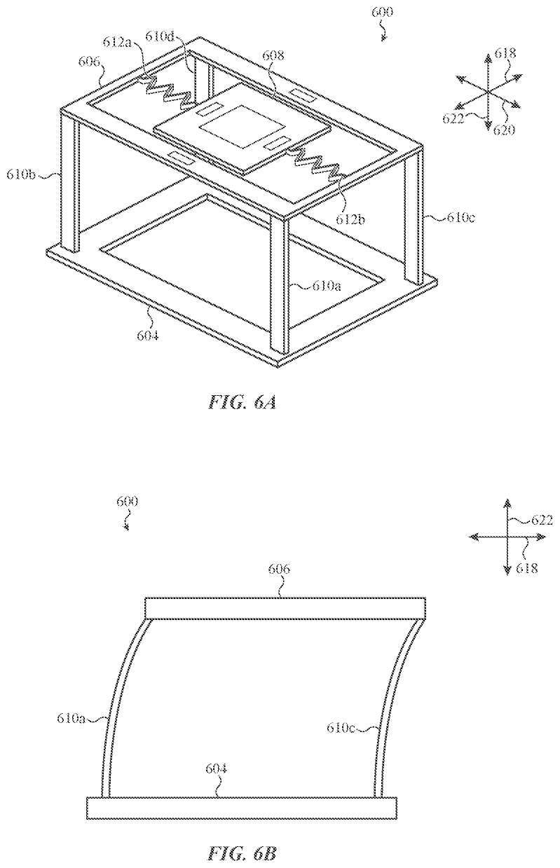

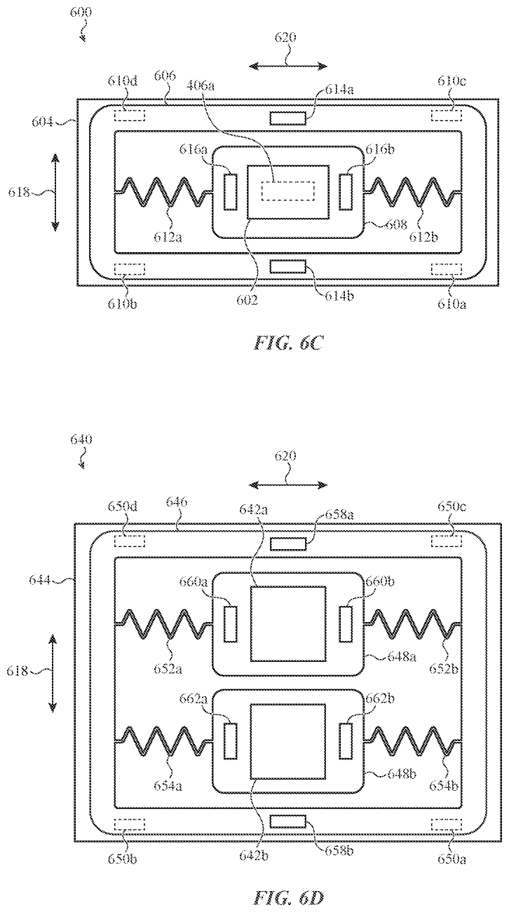

In other variations of the electromagnetic actuator arrangements described herein, an electromagnetic actuator arrangement includes a suspended carrier that is vertically offset and moveable relative to a stationary base. For example, FIGS. 6A-6C show perspective, side, and top views, respectively, of an example of an electromagnetic actuator arrangement 600 that includes a suspended carrier configured to move an optical element 602 (which may be any optical element 602 as described herein) relative to a stationary base 604. Specifically, the suspended carrier includes an intermediate carrier 606 and an inner carrier 608. The suspended carrier may be planar, such that the components of the suspended carrier are positioned (and for some components, moveable) within a plane. The electromagnetic actuator arrangement 600 is controllable to move the optical component 602 in multiple planar directions within this plane.

The suspended carrier (e.g., the intermediate carrier 606 and the inner carrier 608) and the stationary base 604 may collectively form a nested carrier, such that the intermediate carrier 606 is selectively moveable relative to stationary base 604 and the inner carrier 608 is selectively moveable relative to the intermediate carrier 606 and thereby is also moveable relative to the stationary base 604. In these variations, however, the suspended carrier is offset from the stationary base 604 along a vertical axis 622, and thus is not planar with the stationary base 604. Specifically, the nested carrier includes a first set of suspension elements 610a-610d and a second set of suspension elements 612a-612b. The intermediate carrier 606 is moveably connected to the stationary base 604 via the first set of suspension elements 610a-610b, and the inner carrier 608 is moveably connected to the intermediate carrier 606 by a second set of suspension elements 612a-612b. Each suspension element of the second set of suspension elements 612a-612b is represented schematically in FIGS. 6A and 6C by a generic spring symbol, though it should be appreciated that these suspension elements may include one or more flexures, sheet springs, or the like, such as described herein with respect to the electromagnetic actuator arrangement 300 of FIG. 3A.

The optical component 602 is carried by and moveable with the inner carrier 608. For example, the optical component 602 may be mounted to the inner carrier 608 such that movement of the inner carrier 608 relative to the stationary base 604 also moves the optical component 602 relative to the stationary base 604. In the variation shown in FIGS. 6A-6C, the electromagnetic actuator arrangement 600 can move the optical component 602 relative to the stationary base 604 along two axes. Specifically, the electromagnetic actuator arrangement 600 can move the optical component 602 along a first lateral direction 618 and a second lateral direction 620. In these instances, the first lateral direction 618 is perpendicular to the second lateral direction 620, and each of the first and second lateral directions 618, 620 are perpendicular to the vertical axis 622 along which the suspended carrier is offset from the stationary base 604. In some instances, the suspended carrier may be a planar carrier, and the first and second lateral directions 618, 620 may represent different planar directions Accordingly, the optical component 602 may be controllably moveable within the plane of the suspended carrier. In some instances, the suspended carrier may be monolithic (i.e., the intermediate carrier 606, the inner carrier 608, and the second set of suspension elements 612a-612b are monolithically formed). For example, these components may be formed from a single sheet of material (e.g., a metal), in which some of the material is removed from the sheet to define the carriers 606, 608 and the second set of suspension elements 612a-612b.

When the electromagnetic actuator arrangement 600 is incorporated into an optical system, the optical component 602 may receive a light beam from an out-of-plane direction (e.g., along the vertical axis 622). The electromagnetic actuator arrangement 600 may be controlled to move the optical component 602 in multiple lateral directions relative to the incoming light beam. For example, the principles described herein with respect to FIGS. 4A-4E may similarly be applied to the electromagnetic actuator arrangement 600 of FIG. 6A. For example, the first light beam 406a generated by the optical system 400 of FIGS. 4A and 4B is shown in FIG. 6C as passing through a portion of the optical component 602 (e.g., which may be configured as the diffuser 420 of the optical system 400). In the variation shown in FIG. 6C, the first beam 406a is oriented such that its cross-sectional length is aligned with (e.g., parallel to) the second direction 620, such that movement of intermediate carrier 606 along the first direction 618 moves the diffuser 620 along the cross-sectional width of the first beam 406a.

As with the electromagnetic actuator arrangements described herein with respect to FIGS. 2A-3C, the motion of the optical component 602 is decoupled between motion of the inner carrier 608 relative to the intermediate carrier 606 and motion of the intermediate carrier 606 relative to the stationary base 604. Specifically, the electromagnetic actuator arrangement 600 controls movement of the optical component along a first lateral axis (e.g., along the first lateral direction 618) by moving the intermediate carrier 606 relative to the stationary base 604 along the first lateral direction 618, such as shown in FIG. 6B, which also moves the inner career 606 relative to the stationary base 604 along the first direction 618. The electromagnetic actuator arrangement 600 controls movement of the optical component along a second lateral axis (e.g., along the second lateral direction 620) by moving the inner carrier 608 relative to the intermediate carrier 606 along the second lateral direction 620.

To facilitate this movement, the electromagnetic actuator arrangement 600 includes multiple sets of actuators, where different sets of actuators are configured to control different directions of movement of the optical component 602. Specifically, the intermediate carrier 606 includes a first set of actuators 614a-614b that is mounted to the intermediate carrier 606 and controls relative movement between the intermediate carrier 606 and the stationary base 604 in the first lateral direction 618, such as described with respect to the intermediate carrier 206 of FIG. 2A. In these instances, because each of first set of suspension elements 610a-610d are oriented along the vertical axis 622 to suspend the carriers 606, 608 relative to the stationary base 604, operation of the first set of actuators 614a-614b will cause the deflection of the first set of suspension elements 610a-610d away from the vertical axis 622 as shown in FIG. 6B.

This relative movement also controls the relative movement between the inner carrier 608 (and thereby the optical component 602) and the stationary base 604 along the first lateral direction 618. In some variations, the intermediate carrier 606 is only controllable to move in the first lateral direction 618. For example, the first set of suspension elements 610a-610b may be configured to prioritize relative movement between the intermediate carrier 606 and the stationary base 604 along the first direction 618. For example, each of the first set of suspension elements 610a-610d may have greater flexibility along the first lateral direction 618 (i.e., may be more easily flexed, bent, or deformed in this direction) than it has flexibility along the second lateral direction 620. For example, in some variations, each of the first set of suspension elements 610a-610d may be thicker along the second lateral direction 620 than along the first lateral direction 618. Accordingly, the first set of suspension elements 610a-610d may resist relative movement between the intermediate carrier 606 and the stationary base 604 in any direction other than the first direction 618. It should be appreciated that there may be some change in the relative height between suspended carrier and the stationary base 604 as the first set of suspension elements 610a-610d deflect to move the suspended carrier along the first lateral direction 618.

Similarly, the inner carrier 608 includes a second set of actuators 616a-616b that is mounted to the inner carrier 608 and controls relative movement between the inner carrier 608 and the intermediate carrier 606 along the second planar lateral 620, such as described herein with respect to the inner carrier 206 of FIG. 2A. In some variations, the inner carrier 608 is controllable to move in only a single direction relative to the intermediate carrier 606. In other words, the electromagnetic actuator arrangement 600 may be unable to controllably move the inner carrier 608 relative to the intermediate carrier 606 in directions other than the second lateral direction 620, such as described in more detail herein with respect to the electromagnetic actuator arrangement 200 (and associated second set of suspension elements 212a-212b) of FIG. 2A.

By decoupling motion of the optical element 602 between the inner carrier 608 and the intermediate carrier 606, the electromagnetic actuator arrangement can be designed to achieve different movement capabilities and operating characteristics in each of the movement axes, such as described in more detail herein. Additionally, because the suspended carrier is vertically offset from the stationary base 604, the overall lateral footprint of the electromagnetic actuator arrangement 600 may be reduced as compared to the electromagnetic actuator arrangements described herein with respect to FIGS. 2A-3C.

The stationary base 604 may be configured in any suitable manner depending on the optical system that incorporates the electromagnetic actuator arrangement 600. For example, the stationary base 604 may be any suitable component (or set of components) to which the first set of suspension elements 610a-610d may be attached. For example, two or more suspension element of the first set of suspension elements 610a-610d may be connected to different components. In other variations, the stationary base 604 may include a monolithic component to which each of the first set of suspension elements 610a-610d is connected. In these instances, the stationary base 604 may define an aperture extending therethrough, for example to accommodate light passing through the stationary base 604 before or after interacting with (e.g., passing through) the optical component 602 and/or to accommodate one or more additional components of an optical system that is positioned at least partially inside the aperture.

While the electromagnetic actuator arrangement 600 of FIGS. 6A-6C is shown as moving a single optical component 602, in other variations the electromagnetic actuator arrangements described herein may be configured to move multiple optical components. For example, in the variation shown in FIGS. 6A-6C, the inner carrier 608 may carry multiple optical components, including optical component 602. In these instances, movement of the inner carrier 608 (e.g., relative to intermediate carrier 606 in the second lateral direction 620 or relative to the stationary base 604 in the first lateral direction 618) will move the multiple optical components. In this way, the multiple optical components are moved together, and may thereby maintain a fixed relationship when moving relative to the stationary base.

In other variations, two optical components may be independently moveable along an axis of the electromagnetic actuator arrangement. For example, FIG. 6D shows a top view of an example of an electromagnetic actuator arrangement 640 that includes a suspended carrier that is configured to independently move both a first optical element 642a and a second optical element 642b relative to a stationary base 644. Specifically, the electromagnetic actuator arrangement 640 includes a nested carrier that includes the stationary base 644 and a suspended carrier that is offset from the stationary base 644 along a vertical axis (not shown), such as described with respect to the electromagnetic actuator arrangement 600 of FIGS. 6A-6C. The suspended carrier includes an intermediate carrier 646, a first inner carrier 648a, and a second inner carrier 648b. The suspended carrier may be planar, and the electromagnetic actuator arrangement 640 may be controllable to move the first and second optical components 642a, 642b in multiple planar directions within this plane. While shown in FIG. 6D as including two inner carriers 648a, 648b, it should be appreciated that the principles described herein may be applied to three or more inner carriers moveably connected to the inner carrier 646, or two or more intermediate carriers connected to the stationary base 644 (each moveably connected to one or more inner carriers).

The nested carrier includes a first set of suspension elements 650a-650d, a second set of suspension elements 652a-652b, and a third set of suspension elements 654a-654b. The intermediate carrier 646 is moveably connected to the stationary base 644 via the first set of suspension elements 650a-650d along the vertical axis (e.g., along the vertical axis 622 depicted in FIG. 6A), and may be controllable to move relative to the stationary base 644 along a first lateral direction 618. Specifically, a first set of actuators 658a-658b is mounted to the intermediate carrier 646, and each of these actuators is controllable (alone or collectively) to apply a force to the intermediate carrier 646 relative to the stationary base 644 along the first lateral direction 618. The stationary base 644, the intermediate carrier 646, the first set of suspension elements 650a-650d, and the first set of actuators 658a-658b may be configured in any manner as described herein with respect to the corresponding components of the electromagnetic actuator arrangement 600 of FIGS. 6A-6C.

The first inner carrier 648a is moveably connected to the intermediate carrier 646 by the second set of suspension elements 652a-652b. Similarly, the second inner carrier 648b is moveably connected to the intermediate carrier 646 by the third set of suspension elements 654a-654b. In some variations, the suspended carrier is monolithic. For example, the intermediate carrier 646, the first and second inner carriers 648a, 648b, and the second and third sets of suspension elements 652a-652b, 654a-654b may be formed from a single sheet of material (e.g., a metal), in which some of the material is removed from the sheet to define the various components of the suspended carrier.

The first and second inner carriers 648a, 648b are independently moveable relative to the intermediate carrier 646 (and thereby the stationary base 644) along a second direction 620, and each may be configured and moved in any manner as described with respect to the first inner and second inner carriers 248a, 248b of the electromagnetic actuator arrangement 240 of FIG. 2D. Specifically, a second set of actuators 660a-660b is mounted to the first inner carrier 648a, and each of these actuators is controllable (alone or collectively) to apply a force to the first inner carrier 648a relative to the intermediate carrier 646 along the second lateral direction 620. Similarly, a third set of actuators 662a-662b is mounted to the second inner carrier 648b, and each of these actuators is controllable (alone or collectively) to apply a force to the second inner carrier 648b relative to the intermediate carrier 646 along the second lateral direction 620.

The first optical component 642a may be carried by (e.g., mounted to) the first inner carrier 648a, such that movement of the first inner carrier 648a relative to the stationary base 644 also moves the first optical component 642a relative to the stationary base 644. The second optical component 642b may be carried by (e.g., mounted to) the second inner carrier 648b, such that movement of the second inner carrier 648b relative to the stationary base 644 also moves the second optical component 648b relative to the stationary base 644. Movement of the intermediate carrier 646 relative to the stationary base 644 in the first direction will also move both the first and second inner carriers 648a, 648b in that direction, and thus the first and second optical components 642a, 642b may be moved together and thereby maintain a fixed relationship along the first lateral direction 618. Along the second lateral direction 620, however, the first optical component 642a may be moved (by virtue of relative movement between the first inner carrier 648a and the intermediate carrier 646) independently of movement of the second optical component 642b (by virtue of relative movement between the second inner carrier 648b and the intermediate carrier 646).

It should be appreciated that electromagnetic actuator arrangement 640 shown in FIG. 6D may be incorporated in the optical system 400 of FIG. 4, and may be used to independently move i) the first optical component 642a (which may be configured as a first diffuser) to interact with a first light beam 406a, and ii) the second optical component 642b (which may be configured as a second diffuser) to interact with a second light beam 406b.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. An optical system comprising:
an electromagnetic actuator arrangement comprising:
a nested carrier comprising:
a stationary base;
a first set of suspension elements;
an intermediate carrier moveably connected to the stationary base via the first set of suspension elements;
a second set of suspension elements; and
an inner carrier moveably connected to the intermediate carrier via the second set of suspension elements;
a diffuser carried by the inner carrier;
a first set of actuators mounted to the intermediate carrier and controllable to move the intermediate carrier relative to the stationary base along a first direction; and
a second set of actuators mounted to the inner carrier and controllable to move the inner carrier relative to the intermediate carrier along a second direction.

2. The optical system of claim 1, comprising:
a beam-generating assembly configured to generate a set of light beams, wherein:
the diffuser is positioned to receive a first light beam of the set of light beams.

3. The optical system of claim 2, wherein:
the first light beam has a cross-sectional shape at the diffuser, the cross-sectional shape having a length that is longer than a width thereof; and
the length is aligned with the second direction.

4. The optical system of claim 1, wherein:
the inner carrier is a first inner carrier;
the nested carrier comprises:
a third set of suspension elements; and
a second inner carrier moveably connected to the intermediate carrier via the third set of suspension elements; and
the optical system comprises a third set of actuators mounted to the second inner carrier and controllable to move the second inner carrier relative to the intermediate carrier along the second direction.

5. The optical system of claim 4, comprising:
an optical element carried by the second inner carrier.

6. The optical system of claim 5, wherein:
the diffuser is a first diffuser; and
the optical element is a second diffuser.

7. The optical system of claim 1 comprising:
a set of detector groups positioned to receive light from the set of light beams that is returned from the sample.

8. The optical system of claim 1, wherein:
the nested carrier is monolithic.

9. An electromagnetic actuator arrangement comprising:
a planar nested carrier comprising:
a stationary base;
a first set of suspension elements;
an intermediate carrier moveably connected to the stationary base via the first set of suspension elements;
a second set of suspension elements; and
an inner carrier moveably connected to the intermediate carrier via the second set of suspension elements;
an optical component carried by the inner carrier;
a first set of actuators mounted to the intermediate carrier and controllable to move the intermediate carrier relative to the stationary base along a first planar direction; and
a second set of actuators mounted to the inner carrier and controllable to move the inner carrier relative to the intermediate carrier along a second planar direction.

10. The electromagnetic actuator arrangement of claim 9, wherein:
the intermediate carrier is controllable to move relative to the stationary base only in the first planar direction; and
the inner carrier is controllable to move relative to the stationary base only in the second planar direction.

11. The electromagnetic arrangement of claim 9, wherein:
the optical component is a diffuser.

12. The electromagnetic actuator arrangement of claim 9, wherein:
the inner carrier is a first inner carrier;
the optical component is a first optical component;
the planar nested carrier comprises:
a third set of suspension elements; and
a second inner carrier moveably connected to the intermediate carrier via the third set of suspension elements; and
the electromagnetic actuator arrangement comprises:
a second optical component carried by the second inner carrier; and
a third set of actuators mounted to the second inner carrier and controllable to move the second inner carrier relative to the intermediate carrier along the second planar direction.

13. The electromagnetic actuator arrangement of claim 12, wherein:
the second optical component is a diffuser.

14. The electromagnetic actuator arrangement of claim 9, wherein:
the planar nested carrier is monolithic.

15. The electromagnetic actuator arrangement of claim 9, wherein:
the first set of suspension elements comprises a first group of suspension elements and a second group of suspension elements;
the first group of the first set of suspension elements connects a first side of the stationary base to a first side of the intermediate carrier facing the first side of the stationary base; and
the second group of the first set of suspension elements connects a second side of the stationary base to a second side of the intermediate carrier facing the second side of the stationary base.

16. The electromagnetic actuator arrangement of claim 9, wherein:
the second set of suspension elements comprises a first group of suspension elements and a second group of suspension elements;
the first group of the second set of suspension elements connects a third side of the intermediate carrier to a first side of the inner carrier facing the third side of the intermediate carrier; and
the second group of the second set of suspension elements connects a fourth side of the intermediate carrier to a second side of the inner carrier facing the fourth side of the intermediate carrier.

17. A method of performing a series of measurements using an optical system comprising an electromagnetic actuator arrangement that comprises a nested actuator, the method comprising:
moving an intermediate carrier of the nested actuator relative to a stationary base of the nested actuator between a first set positions along a first direction;
collecting a set of measurements at each of the first set of positions along the first direction, comprising:
moving an inner carrier of the nested actuator relative to the intermediate carrier between each of a second set positions along a second direction different from the first direction; and
performing, using an optical component carried by the inner carrier, an individual measurement of set of measurements at each of the second set of positions along the second direction.

18. The method of claim 17, wherein:
the optical component is a diffuser; and
performing, using the optical component carried by the inner carrier, the individual measurement comprises diffusing a light beam using the diffuser.

19. The method of claim 18, wherein:
the light beam has a cross-sectional shape at the diffuser, the cross-sectional shape having a length that is longer than a width thereof; and
the length is aligned with the second direction.

20. The method of claim 17, comprising:
collecting an additional set of measurements at each of the first set of positions along the first direction, comprising:
moving an additional inner carrier of the nested actuator relative to the intermediate carrier between each of a third set of positions along the second direction; and
performing, using an additional optical component carried by the additional inner carrier, an additional individual measurement of set of measurements at each of the third set of positions along the second direction.
